(19) United States
(12) Patent Application Publication
(10) Pub. No.: US 2024/0227498 A1
(43) Pub. Date: Jul. 11, 2024

(54) SYSTEM AND METHOD FOR MONITORING AND CONTROLLING AIR QUALITY IN AN ENCLOSED SPACE

(71) Applicant: BREATHESAFE PTY LTD, Queensland (AU)

(72) Inventors: Nicholas Liam Johnstone, Queensland (AU); Alexander Zangerl, Queensland (AU)

(21) Appl. No.: 18/294,724

(22) PCT Filed: Aug. 5, 2022
(86) PCT No.: PCT/AU2022/050852

§ 371 Date: Feb. 2, 2024

(30) Foreign Application Priority Data
Aug. 5, 2021 (AU) 2021902424
Aug. 25, 2021 (AU) 2021221799

(51) Int. Cl. B60H 1/00; B60H 3/06

(52) U.S. Cl. CPC B60H 1/008; B60H 1/00828; B60H 3/06

(57) ABSTRACT

A system for monitoring and controlling environmental parameters in an enclosed space comprising a controller and sensors to monitor environmental parameters inside the enclosed space. The sensors include at least one pressure sensor to sense the pressure inside and outside the enclosed space, at least one dust sensor to sense dust particles in the enclosed space and at least one CO2 sensor to sense CO2 in the enclosed space. The controller and sensors are in operative communication. The controller receives one or more input signals from the sensors. In response to the input signals the controller generates output signals that are sent to an air pressuriser and/or an air filtration unit to control the operation of the air pressuriser and/or the air filtration unit to control at least some environmental parameters relating to air quality inside the enclosed space.

Throughout this specification, unless the context requires otherwise, the word “comprise” and variations such as “comprises”, “comprising” and “comprised” are to be understood to imply the presence of a stated integer or group of integers but not the exclusion of any other integer or group of integers.

Throughout this specification, unless the context requires otherwise, the word “include” and variations such as “includes”, “including” and “included” are to be understood to imply the presence of a stated integer or group of integers but not the exclusion of any other integer or group of integers.

The headings and subheadings in this specification are provided for convenience to assist the reader, and they are not to be interpreted so as to narrow or limit the scope of the disclosure in the description, claims, abstract or drawings.

### FIELD

The present invention relates to a system and method for monitoring and controlling air quality in an enclosed space. More generally, the present invention relates to a system and method for monitoring and controlling environmental parameters (i.e. at least some environmental parameters) in an enclosed space. The enclosed space may be, for example, a cabin or cabinet. Examples of environmental parameters in the enclosed space that may be controlled include dust contaminant levels and levels of undesirable gases such as, for example, carbon dioxide, hydrogen sulfide and sulphur dioxide (CO₂, H₂S and SO₂).

### BACKGROUND

Any discussion of background art, any reference to a document and any reference to information that is known or is well known, which is contained in this specification, is provided only for the purpose of facilitating an understanding of the background art to the present invention, and is not itself an acknowledgement or admission that any of that material forms part of the common general knowledge in Australia or any other country as at the priority date of the application in relation to which this specification has been filed.

In some situations, most usually in some industrial and commercial situations, the environment conditions may have adverse impacts for personnel even if they are operating in an enclosed space and for equipment even if the equipment is housed in an enclosed space. These adverse impacts arise due to the presence of contaminants in the ambient environment. In the case of personnel, the enclosed space may be the cabin of a vehicle or a building (e.g. a demountable building) located at an industrial or commercial site. In the case of equipment, the enclosed space may be a cabinet housing the equipment or may be the cabin of an autonomous vehicle. However, even in the case of equipment, the enclosed space may be the entire building (e.g. a demountable building) or on-site server rooms housing servers.

By way of example, the vehicle may be a heavy earth moving vehicle, under control of an operator located in the cabin of the vehicle, conducting works at a site where contaminants, e.g. dust and/or undesirable gases, may be present in the ambient environment at the site. Undesirable gases, for example, include gases such as carbon dioxide, hydrogen sulfide and sulphur dioxide (CO₂, H₂S and SO₂). Similarly, by way of example, the cabinet may house sensitive electrical or electronics equipment located at a site where contaminants, e.g. dust and/or undesirable gases, may be present in the ambient environment at the site. Examples of sites where dust and/or undesirable gases may be present in the ambient environment at the site include mine sites (both above-ground and below-ground mine sites), drilling sites (e.g. drilling for oil and/or gas), construction sites and chemical and mineral processing sites.

Exposure to the ambient environment at such sites may have adverse implications for the health and safety of personnel. Similarly, exposure to the ambient environment at such sites may have adverse implications for the operability and service-life of the equipment. Consequently, personnel operating at such sites may need to avoid undue exposure to the ambient environment so as to avoid potentially adverse implications for the health and safety of the personnel. Similarly, it may be necessary that equipment at such sites should avoid undue exposure to the ambient environment so as to avoid potentially adverse implications for the operability and service-life of the equipment.

Locating personnel in an enclosed space of a vehicle cabin or building and housing sensitive equipment in an enclosed space of a cabinet may not provide sufficient protection or shielding from exposure under all conditions as exposure may occur, for example, due to entry of ambient air into the enclosed space through gaps in the sealing arrangements of the cabin, building or cabinet and/or through the air intake arrangements of these structures. Entry of contaminated ambient air from the external ambient environment into the enclosed space would then result in the undesirable exposure of personnel and/or equipment to the contaminants in the ambient air that has entered the enclosed space.

### SUMMARY

In accordance with one aspect of the present invention, there is provided a system for monitoring and controlling environmental parameters in an enclosed space comprising
a controller,
at least first sensors to monitor environmental parameters inside the enclosed space, the sensors including
   at least one pressure sensor to sense the pressure inside and outside the enclosed space,
   at least one dust sensor to sense the presence of dust particles in the enclosed space,
   at least one CO₂ sensor to sense the presence of CO₂ in the enclosed space, and
wherein the controller and the first sensors are in operative communication such that, in use, the controller receives one or more input signals from the first sensors and in response to the input signals the controller is able to generate one or more output signals that are sent to an air pressuriser and/or an air filtration unit to control the operation of the air pressuriser and/or the air filtration unit to thereby control at least some environmental parameters relating to air quality inside the enclosed space.

In accordance with another aspect of the present invention, there is provided a system for monitoring and controlling environmental parameters in an enclosed space comprising
a controller,
at least first sensors to monitor parameters indicative of air quality inside the enclosed space, the first sensors including
   at least one pressure sensor to sense the pressure inside and outside the enclosed space,
   at least one dust sensor to sense the presence of dust particles in the enclosed space,
   at least one CO₂ sensor to sense the presence of CO₂ in the enclosed space, and
an air pressuriser to filter and deliver air from outside the enclosed space into the enclosed space,
an air filtration unit to filter air within the enclosed space,
wherein the controller and the first sensors are in operative communication such that, in use, the controller receives one or more input signals from the first sensors and in response to the input signals the controller generates one or more output signals that are sent to the air pressuriser and/or the air filtration unit to control the operation of the air pressuriser and/or the air filtration unit to thereby control at least some environmental parameters relating to air quality inside the enclosed space.

The air pressuriser is located such that it is able to draw air from outside the enclosed space and direct the air into the enclosed space.

Air that passes through the air pressuriser is directed into the enclosed space.

The air pressuriser may be located outside or inside the enclosed space.

The air filtration unit is located such that it is able to draw air from inside the enclosed space and direct the air into the enclosed space.

The air filtration unit may be located inside or outside the enclosed space.

In use of the system, a filter, provided in the air pressuriser, filters the air that passes through the air pressuriser and the air, which has been filtered, is directed into the enclosed space.

In use of the system, a filter, provided in the air filtration unit, filters the air that passes through the air filtration unit and the air, which has been filtered, is directed into the enclosed space.

The environmental parameters may be in respect of air quality, i.e. monitoring and controlling air quality in an enclosed space.

Control of the operation of the air pressuriser and/or the air filtration unit comprises adjusting the speed of the respective motor of the air pressuriser and/or the air filtration unit if an input signal issued by a sensor and received by the controller indicates that the corresponding environmental parameter is not at a predetermined value or within a predetermined value range. An alarm may be raised to alert the operator if an environmental parameter is not at the predetermined value, or within the predetermined value range, for a set time period. The set time period may be adjustable. This may be done in respect of all environmental parameters or only selected environmental parameters.

The first sensors may further include at least one airflow sensor to sense the airflow in the enclosed space. The at least one airflow sensor may sense the rate of flow of air in and/or into the enclosed space.

The first sensors may further include one or more sensors to sense the presence of one of more other gases (i.e. other than CO₂) in the enclosed space. The other gases, for example, may be one or more of SO₂, H₂S. However, sensors for any other gases may be included.

The controller determines if the pressure sensed in the enclosed space falls below a predetermined level and then sends an output signal to the motor of the air pressuriser to reduce the speed of the motor.

The system performs a pressure test upon start-up to detect the current relationship between the speed of the motor of the air pressuriser and air pressure in the enclosed space.

The system may employ PID control. For example, PID control may be used to calculate a motor speed correction for the motor of the air pressuriser and/or the motor of the air recirculation unit.

The controller signals an alert if the motor of the air pressuriser is running at or near its full speed and the pressure sensed inside the enclosed space is below a predetermined value.

The system may also comprise second sensors. The second sensors sense parameters other than the parameters sensed by the first sensors. The second sensors do not monitor parameters that are indicative of the air quality inside the enclosed space. The second sensors monitor parameters that may affect the comfort level of a (human) operator in the enclosed space.

The first sensors are also referred to herein as the ‘first set of sensors’ or the ‘first sensors set’. The second sensors are also referred to herein as the ‘second set of sensors’ or the ‘second sensors set’.

The second sensors set may be divided into two groups: the first group of second sensors sense parameters and may issue input signals to the controller which in turn generates one or more output signals that are sent to the air pressuriser and/or the air filtration unit to control the operation of the air pressuriser and/or the air filtration unit. However, in the case of the second sensors in this first group, the purpose of controlling the operation of the air pressuriser and the air filtration unit is not to control the air quality inside the enclosed space, but rather to improve the comfort level of the environment of the enclosed space for the operator. The second group of second sensors sense parameters and issue input signals to the controller, but the controller does not generate and send output signals, in response thereto, to control the operation of the air pressuriser and/or the air filtration unit. In the case of the second group of second sensors, the input signals received by the controller are stored in a data store.

Sensors of the type in the first group of the second group of sensors include a sound sensor and/or a vibration sensor.

Accordingly, the system may further comprise at least one sound sensor to sense the sound level inside the enclosed space. The sound sensor may measure the sound level inside the enclosed space in decibels. The sound sensor may thus provide a reading of the sound level to which the occupant/s of the enclosed space are exposed.

The system may also further comprise at least one vibration sensor to sense vibration inside the enclosed space. The vibration sensor may detect the level of vibration inside the enclosed space. The vibration sensor may thus provide a reading of the level of vibration to which the occupant/s of the enclosed space, and/or equipment in the enclosed space, are exposed. Such readings may be saved in in a data store, which is accessible. The data store thereby provides a record of the vibration levels experienced by the occupant/s of the enclosed space and/or equipment in the enclosed space.

Sensors of the type in the second group comprise a temperature sensor and a relative humidity sensor.

Accordingly, the system may further comprise at least one temperature sensor to sense the temperature inside the enclosed space.

Accordingly, the system may further comprise at least one relative humidity detector to sense the relative humidity inside the enclosed space.

One or more of the first sensors and second sensors may be provided in a sensor pod. For example, the dust sensor, CO₂ sensor, sensor/s for other gases, temperature sensor and relative humidity sensor may be provided in a single sensor pod. In alternative embodiments, one or more of these sensors may be provided in two or more sensor pods.

If required, the system may further comprise one or more interfaces with the controller. By way of example, three different types of interfaces are described herein. A first interface comprises a user interface with the controller. The first interface allows a user, e.g. an operator located in the enclosed space, to interact with the controller. The second interface comprises a web interface. The system may have a built-in wi-fi network. The web interface allows a user to connect with the controller via the built-in wi-fi network using a suitable device, e.g. a (laptop) computer or smartphone. As an alternative or in addition to the system having a built-in wi-fi network, the controller may be connectable to external networks via wi-fi, ethernet and/or USB interfaces. For example, the system may interface with a USB LTE adaptor to connect to an external network. The third type of interface comprises an interface between the system and an OEM system. This third type of interface may be required, for example, if the enclosed space (or another device with which the enclosed space is associated, for example, a vehicle) has an OEM system that it is desired to interface with the system of the present invention.

The enclosed space (in which the air quality is monitored and controlled) may be a cabin or cabinet. The cabin, for example, may be the cabin of a vehicle. One or more operators of the vehicle may occupy the cabin when the vehicle is in use and/or equipment may be located in the cabin. The cabinet, for example, may be a cabinet containing equipment (e.g. electronics equipment). However, the enclosed space may be a building (including a demountable building) or a room occupied by personnel and/or in which equipment is located.

The system may be provided to monitor and control air quality in an enclosed space as a retrofitted installation. Alternatively, the system of the present invention may be provided in an enclosed space at the time of manufacture of the enclosed space or product having the enclosed space, for example, a vehicle. In a further alternative, the system of the present invention may be provided in an enclosed space as an upgrade of an existing system in the enclosed space.

In accordance with another aspect of the present invention, there is provided a method for monitoring and controlling environmental parameters in an enclosed space comprising
sensing the respective pressures inside the enclosed space and outside the enclosed space,
determining the differential pressure between the sensed pressure inside the enclosed space and the sensed pressure outside the enclosed space,
sensing the presence of dust particles in the enclosed space,
sensing the presence of CO₂ in the enclosed space,
generating one or more input signals indicative of the pressure differential, presence of dust particles and presence of CO₂ in the enclosed space,
generating one of more output signals in response to the input signals,
sending the output signals to an air pressuriser and/or an air filtration unit to control the operation of the air pressuriser and/or the air filtration unit to thereby control at least some environmental parameters relating to air quality inside the enclosed space.

Control of the operation of the air pressuriser and/or the air filtration unit comprises adjusting the speed of the respective motor of the air pressuriser and/or the air filtration unit if an input signal indicates that the corresponding environmental parameter is not at a predetermined value or within a predetermined value range.

The method may further comprise determining if the pressure sensed in the enclosed space falls below a predetermined level and sending an output signal to the motor of the air pressuriser to reduce the speed of the motor.

The method may further comprise performing a pressure test upon start-up to detect the current relationship between the speed of the motor of the air pressuriser and air pressure in the enclosed space.

The method may further comprise employing PID control. For example, PID control may be used to calculate a motor speed correction for the motor of the air pressuriser and/or the motor of the air recirculation unit.

The method may further comprise issuing an alert if the motor of the air pressuriser is running at or near its full speed and the pressure sensed inside the enclosed space is below a predetermined value.

Readings for the environmental parameters monitored may be recorded in a data store.

The system and method do not aim to monitor and control every environmental parameter in the enclosed space. In addition, the present invention does not necessarily control every environmental parameter that is monitored, for example, in the case of the enclosed space being the cabin of a vehicle, whilst temperature and relative humidity may be monitored, control of these parameters is usually handled by the existing HVAC system of the vehicle. However, monitoring such environmental parameters enables the readings from the monitoring to be recorded in a data store. Examples of other parameters that may be monitored and recorded in the data store include one or more of: the dust particle count; particle concentrations for various sizes of particles; typical dust particle size; air pressure; alert times, severity and details; and system changes and the identity of the personnel who made the change. The data store can be accessed to analyse the data readings and fluctuations of the environmental parameter/s. This may be useful to identify any shortfalls in system performance which can then be investigated further and remedied if required.

Some of the environmental parameters monitored may relate to air quality. Examples of environmental parameters that relate to air quality include the differential pressure level in the enclosed space, the level (or concentration) of dust particles, the level (or concentration) of CO₂ or other undesirable gases (e.g. SO₂, H₂S), airflow in the enclosed space and airflow into the enclosed space. The differential pressure level in the enclosed space can relate to air quality because, for example, if the differential pressure level is not sufficiently high and the ambient environment outside the enclosed space has a relatively higher dust level, dust particles may find their way into the enclosed space thereby reducing the air quality in the enclosed space. Thus, the differential pressure level needs to be maintained as a positive pressure level or an overpressure level in the enclosed space. The level (or concentration) of CO₂ or other undesirable gases (e.g. SO₂, H₂S) can relate to air quality because such gases can present serious adverse health effects on an occupant/s of the enclosed space and/or may be damaging to sensitive equipment in the enclosed space. The airflow in the enclosed space (i.e. recirculated air in the enclosed space) can relate to air quality because, for example, if the level of dust detected in the enclosed space is undesirably high, the airflow needs to be at a sufficiently high level to flow air through the air filtration unit to filter the dust from the air. The airflow into the enclosed space (i.e. the flow of air from outside the enclosed space into the enclosed space) can relate to air quality because, for example, if the level of an undesirable gas in the enclosed space is undesirably high, the airflow into the enclosed space needs to be at a sufficiently high level to flush out the undesirable gas from the enclosed space and replace it with fresh air. In such a case, the air flowing into the enclosed space needs to be clean (e.g. filtered air) so that the inflowing air does not contaminate the enclosed space.

Some environmental parameters monitored may relate to the perceived comfort level of an occupant of the enclosed space. Examples of environmental parameters that relate to the perceived comfort level of an occupant of the enclosed space include the sound (or noise) level and the vibration level in the enclosed space.

### BRIEF DESCRIPTION OF DRAWINGS

The present invention will now be described, by way of example only, with reference to the accompanying drawings, in which:

FIG. 1A is a first perspective view of the cabin of a vehicle incorporating an installation of an embodiment of a system for monitoring and controlling environmental parameters in an enclosed space in accordance with an aspect of the present invention;

FIG. 1B is a second perspective view of the cabin shown in FIG. 1A;

FIG. 2 is a side elevation view of the vehicle cabin shown in FIG. 1A;

FIG. 3 is a schematic view of a sensor pod of the system for monitoring and controlling environmental parameters in an enclosed space installed in the vehicle cabin shown in FIG. 1A; and

FIGS. 4A to 4K show embodiments of process flow diagrams of technical operational processes of the system for monitoring and controlling environmental parameters in an enclosed space installed in the vehicle cabin shown in FIG. 1A.

### DESCRIPTION OF EMBODIMENTS

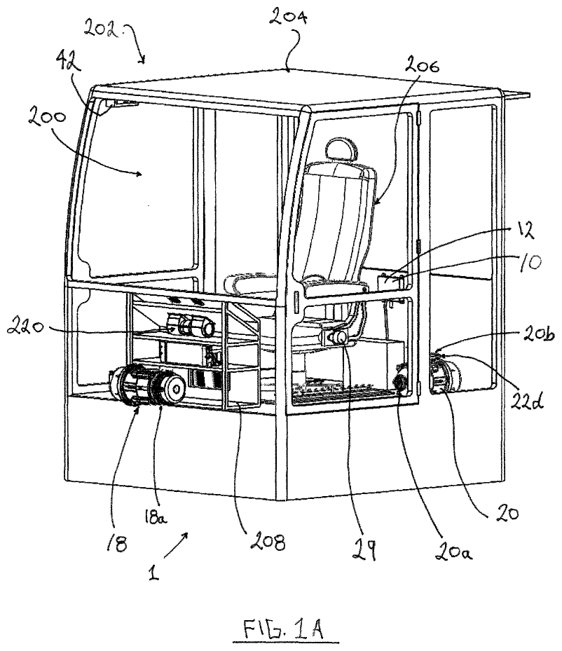

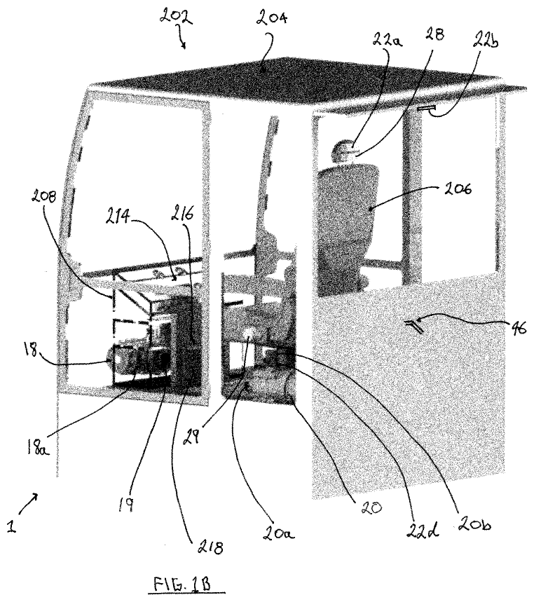

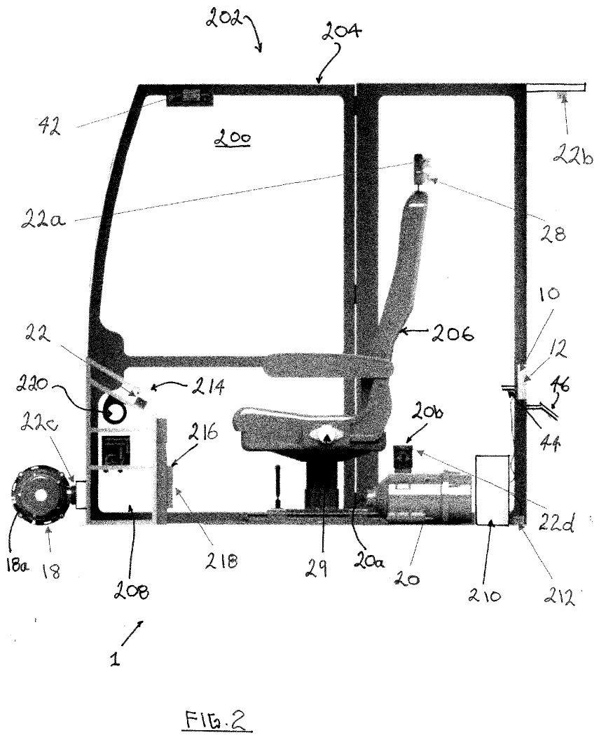

In FIGS. 1A, 1B and 2, an embodiment of a system 1 for monitoring and controlling environmental parameters in an enclosed space is shown installed in a vehicle. In the embodiment described and illustrated, the enclosed space 200 is the inside of the cabin 202 of the vehicle. The vehicle itself does not form part of the present invention. The vehicle is typically a heavy equipment vehicle as used, for example, on mining sites and construction sites. However, the system and method for monitoring and controlling environmental parameters in an enclosed space are not limited to use with a vehicle. The system and method may be used in any suitable enclosed space in which it is desired to monitor and control environmental parameters in the enclosed space. Such suitable enclosed spaces, for example, include buildings (including demountable building), rooms and cabinets housing sensitive electrical or electronics components, e.g. servers. Furthermore, the system and method may be used as a safeguard for the health and safety of operators in an enclosed space, and protection of equipment in an enclosed space or both.

Some of the environmental parameters that are monitored may relate to the air quality in the enclosed space 200. Examples of such environmental parameters include air pressure, dust levels, CO₂ levels, levels of undesirable gases (e.g. SO₂, H₂S) and airflow.

Some environmental parameters monitored may relate to the perceived comfort level of an occupant of the enclosed space. Examples of such parameters include sound or noise levels and vibration levels.

The cabin 202 has a shell 204 that encloses the enclosed space 200. The shell 204 is typically made from metal and glass. The shell 204 sealingly, i.e. in a sealing manner, encloses the enclosed space 200 to reduce the ability of outside contaminants in the outside air to enter the enclosed space 200, i.e. to isolate the enclosed space 200 from the external environment outside the cabin 202. A seat 206 is provided in the enclosed space 200 of the vehicle for the operator of the vehicle.

The cabin 202 includes operational and electrical equipment for the operation and control the vehicle. This equipment typically includes an HVAC (heating, ventilation and air conditioning) system 208. An OEM system 210, i.e. an OEM computer, may be included as part of this equipment. This equipment may include a VMS (vehicle monitoring system) 212.

The HVAC system 208 has an air outlet 214 and an air return 216. Air from within the enclosed space enters the HVAC system 208 via the air return 216. A filter 218 is provided at the air return 216. To provide enhanced filtering, a HEPA (high efficiency particulate air) filter used as the filter 218. The HVAC system has a fan 220 which directs air from the HVAC system 208 out through the air outlet 214 into the enclosed space 200.

### System Overview

The system 1 comprises a controller, or control unit, 10 and sensors.

The sensors comprise at least a first set of sensors. Sensors in the first set of sensors monitor parameters that are indicative of the air quality in the enclosed space.

The sensors may also comprise a second set of sensors. Sensors in the second set of sensors monitor parameters that are indicative of the perceived comfort level (for an occupant, such as an operator of the vehicle) in the enclosed space.

Sensors in the second set of sensors may be divided into a first group of sensors and a second group of sensors, as is further described herein.

The first set of sensors include at least one pressure sensor 12 to sense the air pressure inside and outside the enclosed space 200, at least one dust sensor 14 to sense the presence of dust particles in the enclosed space 200 and at least one CO₂ sensor 16 to sense the presence of CO₂ in the enclosed space 200.

Dust sensors may be referred to by other terms, e.g. particulate mass sensors, PM sensors.

The system 1 further comprises an air pressuriser 18, which has a filter. In FIGS. 1A, 1B and 2, the air pressuriser 18 is shown as located outside the enclosed space 200. The air pressuriser 18 draws air from outside the cabin 202, i.e. from outside the enclosed space 200, via an inlet 18a. The air drawn into the air pressuriser 18 typically contains dirt and dust particles and possibly other contaminants, such as undesirable gases. The air drawn into the air pressuriser 18 then passes through the filter in the air pressuriser 18 to filter the air (i.e. filtered air). This filtering removes a significant proportion of the dirt and dust particles from the air. The air pressuriser 18 has an outlet 19 for filtered air (best seen in FIG. 1B) from which the filtered air exits. The filtered air is then directed into the enclosed space 200 through an opening in the wall of the cabin 202. The filtered air from the filtered air outlet 19 may flow into the HVAC system 208. A fan or impeller (or a similar device) is provided in the air pressuriser 18. The fan or impeller is driven by a motor located inside the air pressuriser 18. The motor drives the fan or impeller which draws air through the air pressuriser 18 and filtered air from the air pressuriser is then delivered into the enclosed space 200. The delivery of the filtered air from the air pressuriser 18 that flows into the enclosed space 200 results in a positive pressure being created in the enclosed space 200 in the cabin 202 such that the air pressure in the enclosed space 200 is greater than the air pressure in the external environment outside the cabin 202.

In an alternative embodiment (not shown), the air pressuriser 18 may be located inside the enclosed space 200. In this alternative embodiment, the air pressuriser 18 is positioned such that it is still able to draw air via the inlet 18a from outside the enclosed space 200 of the cabin 202.

Although the shell 204 sealingly encloses the enclosed space 200, in practice, it is virtually impossible to create a perfectly sealed enclosed space 200 in a vehicle cabin 202. Consequently, there will be small gaps that may result in leaks which could allow air and foreign matter to enter the enclosed space 200 in the cabin 202. Maintaining a level of positive pressure in the enclosed space 200 inside the cabin 202 acts to mitigate entry of air from outside the cabin 202 into the enclosed space 200 inside the cabin 202, thereby reducing entry of dust particles and other contaminants carried by or mixed in with the air outside the cabin 202, e.g. undesirable gases and odours.

The system 1 may further comprise an air filtration unit 20, which has a filter. In FIGS. 1A, 1B and 2, the air filtration unit 20 is shown as located inside the enclosed space 200. The air filtration unit 20 draws air from inside the cabin 202, i.e. from within the enclosed space 200, via an inlet 20a. The air then passes through the filter in the air filtration unit 20 to filter the air (i.e. filtered air). This filtering removes dirt and dust particles from the air and may also remove undesirable gases. The filtered air is directed into the enclosed space 200 via an outlet 20b of the air filtration unit 20.

The air filtration unit 20 may be of similar structure to the air pressuriser 18 and has a fan or impeller (or a similar device) provided therein. The fan or impeller is driven by a motor located inside the air filtration unit 20. The motor drives the fan or impeller which draws air though the air filtration unit 20 and back into the enclosed space 200.

The type of filter used in the air filtration unit 20, for example, may be a glass fibre media HEPA filter. This type of filter is suitable to filter dust and dirt particles. However other types of filters may be used. For example, to also filter out undesirable gases from the air, a HEPA filter may be provided to filter the dirt and dust particles from the air, followed by an activated carbon filter to filter out the gases and then through another HEPA filter to provide an additional safety margin. The type of filter selected for use in the air filtration unit 20 will depend upon the type of contaminants in the working environment of the enclosed space 200.

The filter used in the air pressuriser 18 may be selected from the same types of filters that may be used in the air filtration unit 20. However, the air pressuriser 18 and air filtration unit 20 do not necessarily have to use identical filters. As with the air filtration unit 20, the type of filter selected for use in the air pressuriser will depend upon the type of contaminants in the working environment of the enclosed space 200.

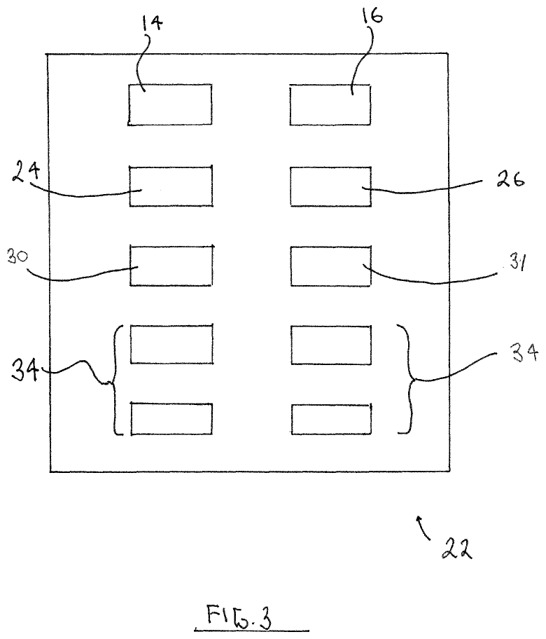

At least some of the sensors of the system 1 may be mounted in one or more sensor pods 22, shown schematically in FIG. 3. The dust sensor 14 and the CO₂ sensor 16, for example, may be mounted in a sensor pod 22.

The system 1 may comprise one or more further sensors, further to the pressure sensor 12, dust sensor 14 and the CO₂ sensor 16.

At least some of the further sensors of the system 1 may be mounted in the sensor pod 22, as shown schematically in FIG. 3.

Such further sensors in the first set of sensors may include one or more sensors 24 and 26 to sense the presence of one of more other gases (i.e. other than CO₂) inside the enclosed space 200. The sensors 24 and 26 may sense the presence of undesirable gases in the enclosed space 200. Such further sensors may be desirable to include if the air outside the enclosed space may contain such undesirable gases and it is desired to monitor for the presence of such gases in the enclosed space 200. The nature of such undesirable gases will depend upon the environment on the exterior of the enclosed space 200. In the case of the enclosed space being the cabin of a heavy equipment vehicle operating in a mining or construction site (as in the present embodiment), the undesirable gases, for example, may be SO₂ and H₂S.

Regarding the further sensors, further sensors in the first group of the second set of sensors may include at least one sound sensor 28 to sense the sound (or noise) level inside the enclosed space 200 and/or at least one vibration sensor 29 to sense vibration inside the enclosed space 200.

Further sensors in a second group of the second set of sensors may include at least one temperature sensor 30 to detect the temperature inside the enclosed space 200 and at least one relative humidity sensor 31 to sense the relative humidity inside the enclosed space 200.

As shown in FIG. 3, the sensors 24 and 26, temperature sensor 30 and relative humidity sensor 31 may be mounted in a sensor pod 22.

The sensor pod 22 shown in FIG. 3 includes four sensor ports 34 that are not in use. These sensor ports 34 may be used to accommodate other sensors should that be required.

The sensor pod 22 may be located at or near to the HVAC system 208, e.g. at or near the air outlet 214 of the HVAC system 208.

The system 1 may comprise more than one dust sensor 14 and/or more than one CO₂ sensor 16. Any such additional sensor/s may be provided at one or more desired locations within the enclosed space 200. For example, an additional dust sensor 14 and an additional CO₂ sensor 16 may be provided at, or near, the breathing zone of the occupant in the enclosed space 200 of the cabin 202. The breathing zone is the air zone around the head of the occupant from which the occupant inhales (breathes in) air. Providing an additional dust sensor 14 and an additional one CO₂ sensor 16 at the breathing zone enables readings of dust particle levels and CO₂ levels to be taken from the immediate vicinity of the occupant's breathe-in air.

The additional dust sensor 14 and the additional CO₂ sensor 16 may be mounted on the seat 206, e.g. on the headrest of the seat 206, such that it is as close as possible to the breathing zone of the occupant (i.e. the operator) when seated in the seat 206.

The additional dust sensor 14 and the additional CO₂ sensor 16 may be mounted in a sensor pod 22a. The sensor pod 22a may be mounted on the seat 206, e.g. on the headrest of the seat 206, as shown in FIG. 2.

The system 1 may comprise more than one sensor for other gases 24/26, more than one temperature sensor 30 and/or more than one relative humidity sensor 31. Any such additional sensor/s may be provided at one or more desired locations within the enclosed space. For example, an additional sensor for other gases 24/26, an additional temperature sensor 30 and/or an additional relative humidity sensor 31 may be provided at the breathing zone of the occupant in the enclosed space 200 of the cabin 202. Providing such additional sensor/s at the breathing zone enables readings of the sensed parameters to be taken from the immediate vicinity of the occupant's breathe-in air.

Any such additional sensor for other gases 24/26, temperature sensor 30 and/or relative humidity sensor 31 may be mounted on the seat 206, e.g. on the headrest of the seat 206.

Any such additional sensor for other gases 24/26, temperature sensor 30 and/or relative humidity sensor 31 may be mounted in a sensor pod, e.g. the sensor pod 22a.

Sensors (such additional dust sensor 14, additional CO₂ sensor 16, additional sensor for other gases 24/26, additional temperature sensor 30 and/or additional relative humidity sensor 31) may be provided outside the enclosed space (i.e. the external ambient environment outside the enclosed space) to provide readings of the parameters sensed and communicate these readings to the controller 10 of the system 1 for data logging and storing purposes. Such readings would then be available for analysis in the event it was desired to do so to ascertain the conditions in the external ambient environment. For example, using external dust sensors to assess the ambient dust concentration levels to which vehicles (including automated and remotely operated vehicles) are exposed. Any such sensors in the external ambient environment may be provided in a similar manner as herein before described with reference to the additional sensors provided at the breathing zone. Any such sensors in the external ambient environment (i.e. external sensors) may be provided in a sensor pod 22b, as shown in FIG. 2.

The provision of such external sensors also enables a protection factor to be determined by the controller 10. For example, in terms of the protection factor that is provided in relation to dust levels, the protection factor may be calculated by dividing the inside dust concentration into the outside dust concentration. If the internal dust sensors 14 indicate that the dust concentration in the enclosed space 200 inside the cabin 202 is 10 parts per m³ and the external dust sensors 14 indicate that the dust concentration outside the cabin 202 is 10,000 parts per m³, the protection factor is calculated by dividing the inside count into the outside count, namely 10,000÷10=1,000, yielding a protection factor of 1,000.

Gathering such data from the external sensors and the internal sensors may be of assistance in determining service life of the filters in the air pressuriser 18 and the air filtration unit 20.

The provision of such external sensors may be beneficial as a safety feature. For example, if the vehicle was to enter an area with a hazardous level of dust, CO₂ or other undesirable/toxic gases, the external sensors would detect the presence of these hazardous levels before the sensors inside the cabin 202 did so. The external sensors would communicate the sensed readings to the controller 10. The controller 10 may then issue a warning which may be displayed on the display of a user interface 42 and a warning buzzer sounded (further described later herein). If necessary, the operator of the vehicle may then drive the vehicle out of the hazardous area to avoid exposure.

The first set of sensors may further include at least one airflow sensor 36 to sense the airflow in or into the enclosed space 200. The airflow sensor 36 may be a mass airflow sensor that senses the amount of airflow. An airflow sensor 36 may be provided at the filtered air outlet 19 of the air pressuriser 18, where the filtered air enters the enclosed space 200 in the cabin 202 from the air pressuriser 18. A temperature sensor 30 may also be provided at the same location as the airflow sensor 36, if desired. The airflow sensor 36 and the temperature sensor 30 may be provided in a sensor pod 22c if desired.

A second airflow sensor 36 may be provided at the outlet 20b of the air filtration unit 20. This second airflow sensor 36 senses the airflow from the air filtration unit 20 in or into the enclosed space 200, i.e. the airflow of filtered air into the enclosed space 200. A temperature sensor 30 may also be provided at the same location as the airflow sensor 36, if desired. The second airflow sensor 36 and the temperature sensor 30 may be provided in a sensor pod 22d if desired.

The sound sensor 28 senses the sound (or noise) level inside the enclosed space 200. The level of sound or noise in the enclosed space 200 is an environmental parameter that may contribute to the perceived comfort level of the occupant of the enclosed space. If the sound (or noise) level in the enclosed space inside the cabin is excessive, the comfort level of the occupant may be adversely affected.

A sound sensor 28 may be provided at one or more desired locations within the enclosed space 200. For example, a sound sensor 28 may be provided at the breathing zone of the occupant in the enclosed space 200 of the cabin 202. Providing a sound sensor at the breathing zone enables readings of the sound (or noise) levels to be taken at the immediate vicinity of the ears of the occupant.

A sound sensor 28 may be mounted on the seat 206, e.g. on the headrest of the seat 206.

The vibration sensor 29 senses the level of vibration in the enclosed space 200. For example, the vibration sensor 29 may sense the level of vibration in the enclosed space 200 to which an occupant in the enclosed space 200 is subjected. The level of vibration in the enclosed space 200 is an environmental parameter that may contribute to the perceived comfort level of the occupant of the enclosed space. If the vibration in the enclosed space inside the cabin is excessive, the comfort level of the occupant may be adversely affected. However, as an alternative to, or in addition to, sensing the level of vibration in the enclosed space 200 to which an occupant is subjected, a vibration sensor 29 may sense the level of vibration in the enclosed space 200 to which equipment in the enclosed space 200 is subjected. Furthermore, the level of vibration to which the enclosed space 200 itself is subjected may, alternatively or additionally, be sensed by a vibration sensor 29.

A vibration sensor 29 may be provided at one or more desired locations within the enclosed space 200. For example, a vibration sensor 29 may be provided beneath, at a side, and/or at the front or rear of the seat 206. Providing a vibration sensor 29 at such a location/s enables readings of the vibration levels to be taken at a location at which vibrations are transferred to the occupant via the seat 206. Similarly, a vibration sensor 29 may be provided on various equipment in the enclosed space 200 to thereby sense the vibration to which that equipment is subjected. Furthermore, one or more vibration sensors 29 may be provided at various other locations in the enclosed space 200 to thereby sense the level of vibration to which the enclosed space 200 is subjected. The readings of the vibration levels that are sensed may be logged and stored in a database. The sensed vibration readings data stored in the database is then available for analysis. A determination may then be made as to whether any vibration levels are excessive and any appropriate action can then be undertaken.

The controller 10 and the sensors are in operative communication such that, in use, the controller receives one or more input signals from the sensors in the first set of sensors. In response to the input signals, the controller 10 is able to generate one or more output signals that are sent to the air pressuriser 18 and/or the air filtration unit 20 to control the operation of the air pressuriser 10 and/or the air filtration unit 10 to thereby control at least some environmental parameters relating to air quality inside the enclosed space.

The controller 10 is in operative communication with the motor of the air pressuriser 18 and can generate output signals that are sent to the motor of the air pressuriser 18 to control the speed of the motor.

The controller 10 is in operative communication with the motor of the air filtration unit 20 and can generate output signals that are sent to the motor of the air filtration unit 20 to control the speed of the motor.

The system 1 may further comprise a user interface 42. The user interface 42 is connected to, but may be physically separated from, the controller 10. The user interface 42 is the first type of interface hereinbefore described. The user interface 42 may comprise a circuit board. The user interface 42 may comprise a microcontroller. The user interface 42 may comprise an enclosure for a keypad and display. However, as an alternative (or addition) to the keyboard and display, a touchscreen may be used. The display may be a backlit display. The user interface 42 may comprise an alert buzzer.

As shown in FIGS. 1A and 2, the user interface 42 may be located on the ceiling of the cabin 202 in the interior space 200, as best seen in FIG. 2. However, the user interface 42 may be located at any suitable location in the interior space 200.

As shown in FIGS. 1A and 2, the controller 10 may be mounted in the enclosed space 200 inside the cabin 202. However, the controller 10 may alternatively be mounted outside the enclosed space 200, e.g. on the exterior of the shell 204 of the cabin 202.

The controller 10 may comprise a single board computer supplemented with an add-on circuit board that interfaces with the various environmental sensors, as herein before described, the keypad and display, and the motors of the air pressuriser 18 and air filtration unit 20.

The system 1 may further comprise a web interface and wi-fi communication function. This may be via a 2.4 GHz connection. The web interface is the second type of interface hereinbefore described. As herein before described, the system 1 may have a built-in wi-fi network and the web interface allows a user to connect with the controller 10 via the built-in wi-fi network using a suitable device, e.g. a (laptop) computer or smartphone. As also herein before described, the controller may (alternatively or in addition) be connectable to external networks via wi-fi, ethernet and/or USB interfaces. The user is then able access the web interface through that network.

The system 1 may further provide an interface with the OEM system 210. This is the third type of interface hereinbefore described. As hereinbefore described, this third type of interface may be required, for example, if the enclosed space 200 (or another device with which the enclosed space is associated, for example, a vehicle) has an OEM system 210 that it is desired to interface with the system 1.

The web interface provides the user with the most functionality. For example, the web interface may provide live dashboard, chart views of all telemetry data, and configuration management that cannot fit onto the display of a user interface 42. The web interface is independent of the other two user interfaces (if one or both of them are provided). When provided, the web interface is usually enabled unless the user changes the configuration to disable the onboard wi-fi network (in which case the web interface could not be accessed, and hence the web interface does not need to be made available and may be disabled to conserve computing resources).

In use, the controller 10 receives input signals from each of the sensors in the system 1 that sense a particular environmental parameter inside the enclosed space 200, e.g. differential air pressure, dust level/concentration, etc. These input signals are indicative of the respective environmental parameters that the sensors are sensing. In response to an input signal from a sensor, the controller 10 generates an output signal that is sent to the relevant respective motor of the air pressuriser 18 and/or air filtration unit 20. The output signals that are sent to the motors cause the relevant motor/s to adjust the speed of the respective motor if the input signal issued by a sensor and received by the controller 10 indicates that the corresponding environmental parameter is not at a predetermined value or within a predetermined value range. The adjustment to the speed will be to either increase or decrease the speed of the relevant motor/s. However, if the input signal issued by a sensor and received by the controller 10 indicates that the corresponding environmental parameter is at a predetermined value or within a predetermined value range, the output signals sent from the controller 10 to the motors do not cause any adjustment in the speed of the motors, i.e. the speeds of the motors remain unchanged (i.e. unadjusted).

Upon receiving an output signal from the controller 10 to adjust the speed, the relevant respective motor of the air pressuriser 18 and/or air filtration unit 20 alters the operating set point of the motor to a higher or lower speed, in accordance with the output signal received from the controller 10. However, if the output signal received by a motor from the controller 10 indicates that no adjustment to the speed of that motor is required, then the speed of that motor remains unaltered (i.e. unadjusted) in response to that output signal.

The normal condition of the system 1 (i.e. system steady state condition) is when all sensors are sensing that the environmental parameters that are being monitored are at the respective predetermined value or within a predetermined value range.

The normal condition for a particular environmental parameter (i.e. parameter steady state condition) is when all sensors monitoring that parameter are sensing that the particular environmental parameter is at the respective predetermined value or within a predetermined value range.

The predetermined value or predetermined value range may be preselected to provide a suitable value for the particular environmental parameter being monitored. For example, the preselection may be based on data obtained from an occupational health and safety authority.

### Pressure Monitoring

By way of example of the operation, a detailed description is provided with particular reference to the pressure sensor 12.

In the embodiment shown in the drawings, the pressure sensor 12 may be provided as a differential pressure sensor that senses the air pressure both in the enclosed space 200 inside the cabin 202 and the air pressure outside the enclosed space, i.e. outside the cabin 202. The difference in the air pressure in the enclosed space 200 inside the cabin 202 and the air pressure outside the enclosed space, i.e. outside the cabin 202, provides a differential air pressure. The system 1 operates to maintain the differential air pressure within a range such that positive pressure is maintained in the enclosed space 200, i.e. such that the air pressure in the enclosed space 200 inside the cabin 202 is higher than the air pressure outside the enclosed space, i.e. outside the cabin 202, by a predetermined value (i.e. a predetermined pressure value) or by an amount that is within a predetermined value range. (i.e. predetermined value range). In relation to the differential pressure, these values are also referred to herein as the predetermined differential pressure value and the predetermined differential pressure range.

By way of example, the predetermined differential pressure value and the predetermined differential pressure range may be selected from the range of 5 Pa and 300 Pa. 5 Pa is typically the minimum useful pressure differential, whilst 300 Pa is typically the maximum pressure differential that should be used in an enclosed space having a human occupant. However, the system capability for the pressure differential may be up to 1,000 Pa.

The pressure sensor 12 is in operative communication with the controller 10. The pressure sensor 12 provides input signals to the controller 10 in relation to the differential air pressure, i.e. signals that are indicative of the sensed differential air pressure. The controller 10 is in operative communication with the motor of the air pressuriser 18 and can generate output signals that are sent to the motor of the air pressuriser 18 to control the speed of the motor. If the controller 10 receives a signal from the pressure sensor 12 that indicates that the differential air pressure has fallen below the predetermined value or below, or outside, the predetermined value range, the controller 10 sends a signal to the motor of the air pressuriser 18 to increase the speed of the motor of the air pressuriser 18. Increasing the speed of the motor increases the speed of the fan or impeller of the air pressuriser 18. Increasing the speed of the fan or impeller increases the volume of fresh air flowing through the air pressuriser 18 into the enclosed space 200 inside the cabin 202. This results in the air pressure rising in the enclosed space 200 inside the cabin 202, thereby increasing the differential air pressure. (Increasing the speed of the fan or impeller increases the speed of rotation of the fan or impeller; conversely, decreasing the speed of the fan or impeller decreases the speed of rotation of the fan or impeller.)

Once the controller 10 receives a signal from the pressure sensor 12 that the differential air pressure has reached the predetermined value or is within the predetermined value range (i.e. the steady state condition for the pressure parameter), the controller 10 sends a signal to the motor of the air pressuriser 18 to maintain the current speed of the motor. Consequently, the speed of rotation of the fan or impeller in the air pressuriser 18 is also maintained unchanged (i.e. unadjusted). Thus, the amount of air flowing into the enclosed space 200 inside the cabin 202 is maintained to maintain the differential air pressure in the enclosed space 200.

Conversely, if the signal that the controller 10 receives from the pressure sensor 12 indicates that the differential air pressure has risen above the predetermined value or above the predetermined value range, the controller 10 sends a signal to the motor of the air pressuriser 18 to decrease the speed of the motor to thereby decrease the speed of the fan or impeller of the air pressuriser 18 to reduce the volume of air flowing into the enclosed space 200 inside the cabin 202. This results in the air pressure falling in the enclosed space 200 inside the cabin 202, thereby decreasing the differential air pressure.

Once the controller 10 receives a signal from the pressure sensor 12 that the differential air pressure has reached the predetermined value or is within the predetermined value range (i.e. the steady state condition for the pressure parameter), the controller 10 sends a signal to the motor of the air pressuriser 18 to maintain the current speed of the motor. Consequently, the speed of rotation of the fan or impeller in the air pressuriser 18 is also maintained unchanged (i.e. unadjusted). Thus, the amount of air flowing into the enclosed space 200 inside the cabin 202 is maintained to maintain the differential air pressure in the enclosed space 200.

Thus, the controller 10 issues a signal to the motor of the air pressuriser 18 in response to a signal received from the pressure sensor 12 to adjust the speed of the motor (either by increase or decrease) to maintain the differential air pressure at the predetermined value or within the predetermined value range.

If the signal that the controller 10 receives from the pressure sensor 12 indicates that the differential air pressure is in accordance with the predetermined value or is within the predetermined value range, the output signal issued by the controller 10 directs the motor of the air pressuriser to maintain the current motor speed, i.e. the speed of the motor remains unchanged.

As can be seen in the embodiment shown in FIG. 2, a first tube 44 extends from the pressure sensor 12 to the enclosed space 200 inside the cabin 202 such that the pressure sensor 12 is exposed to the air in the enclosed space 200 whereby the pressure sensor 12 is able to sense the air pressure in the enclosed space 200. A second tube 46 extends from the pressure sensor 12 outside the enclosed space 200, i.e. outside the cabin 202, such that the pressure sensor is exposed to air outside the enclosed space 200, i.e. outside the cabin, whereby the pressure sensor 12 is able to sense the air pressure outside the cabin, i.e. outside the enclosed space 200.

As shown in FIG. 2, the pressure sensor 12 may be mounted on the controller 10.

In an alternative (not shown), two pressure sensors may be provided. In the alternative embodiment of two pressure sensors being provided, one pressure sensor senses the air pressure in the enclosed space 200 inside the cabin 202 and the other pressure sensor senses the air pressure outside the cabin 202. Each of these pressure sensors sends signals to the controller 10 in relation to the air pressure sensed by the respective pressure sensor, i.e. signals that are indicative of the respective sensed air pressure in the enclosed space 200 inside the cabin 202 and outside the cabin 202. The controller 10 receives the signals from the two pressure sensors and calculates the differential air pressure. The controller 10 then functions in the manner herein before described with reference to the embodiment in which the pressure sensor 12 is a differential pressure sensor.

### Dust Monitoring

Each dust sensor 14 is in operative communication with the controller 10. Each dust sensor 14 provides input signals to the controller 10 in relation to dust level in the enclosed space 200.

The system 1 operates to maintain the dust level in the enclosed space 200 below a predetermined value (i.e. predetermined dust value).

The controller 10 may be responsive to an input signal from a dust sensor 14 by adjusting the speed of the respective motor (and thereby adjust the speed of the associated respective fan or impeller) of the air filtration unit 20 or the air pressuriser 18 or both.

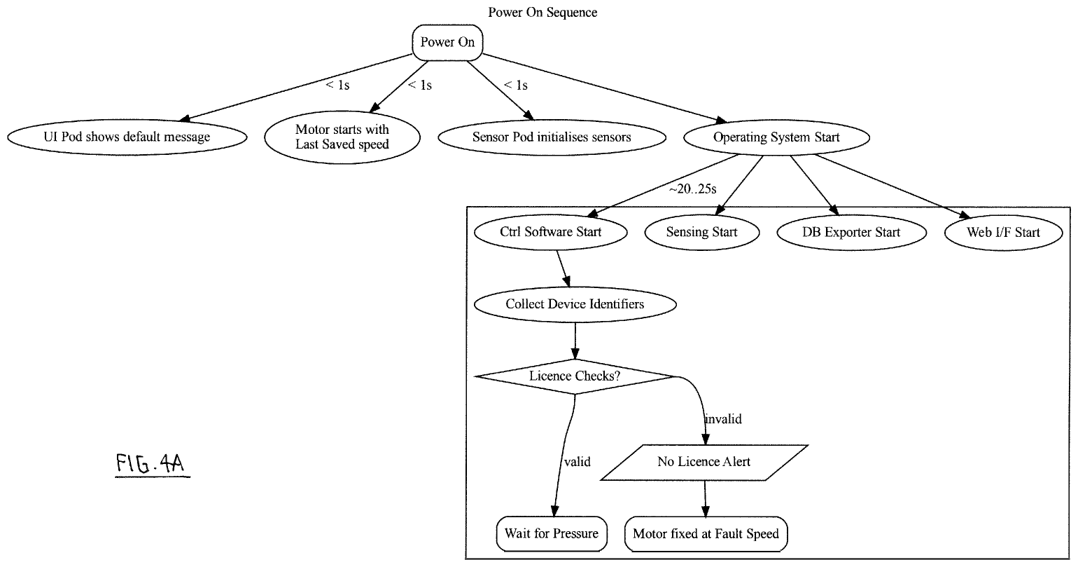

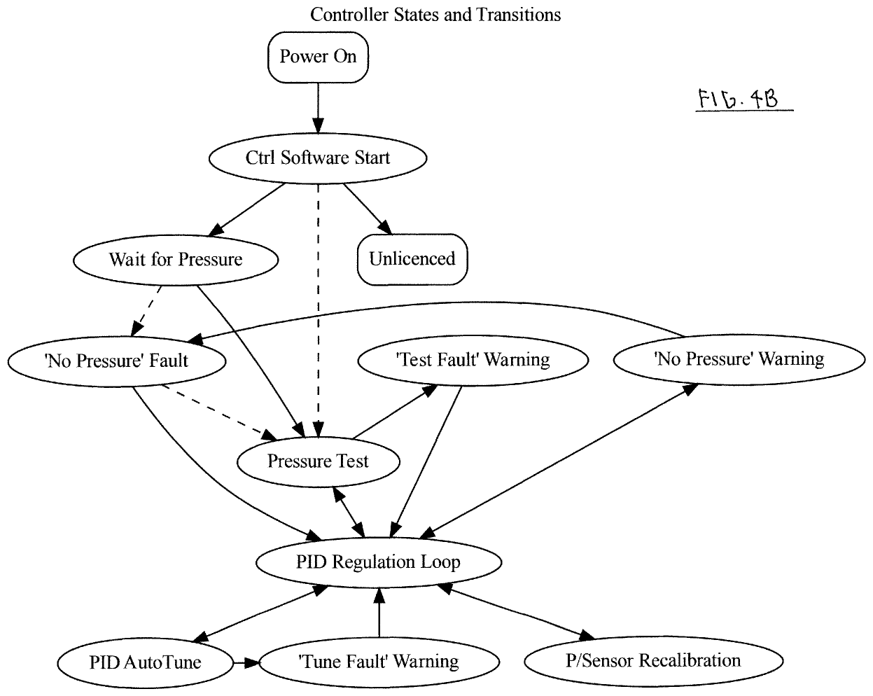

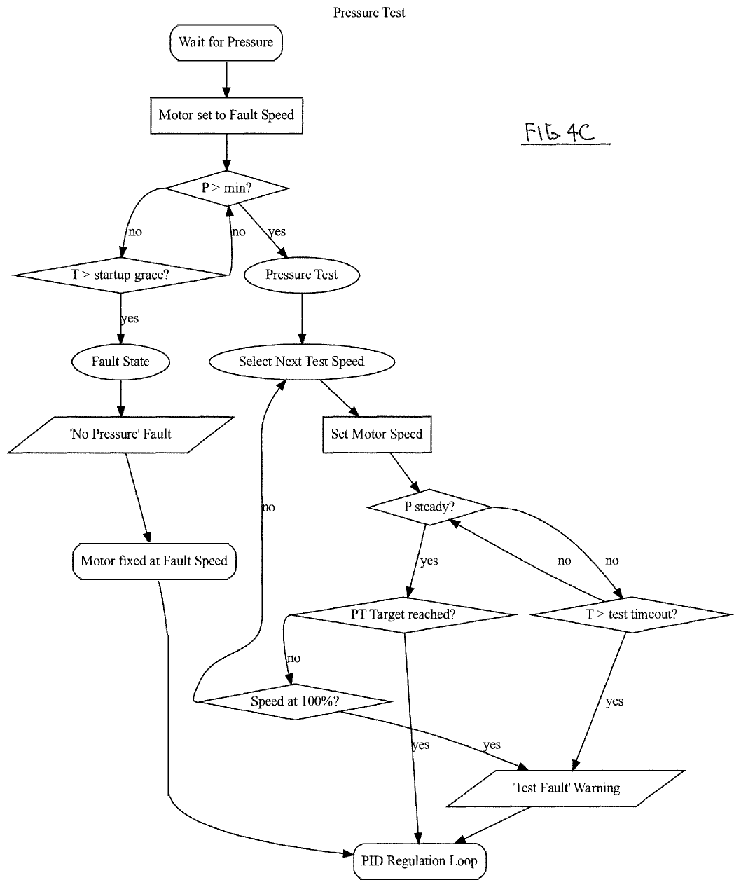

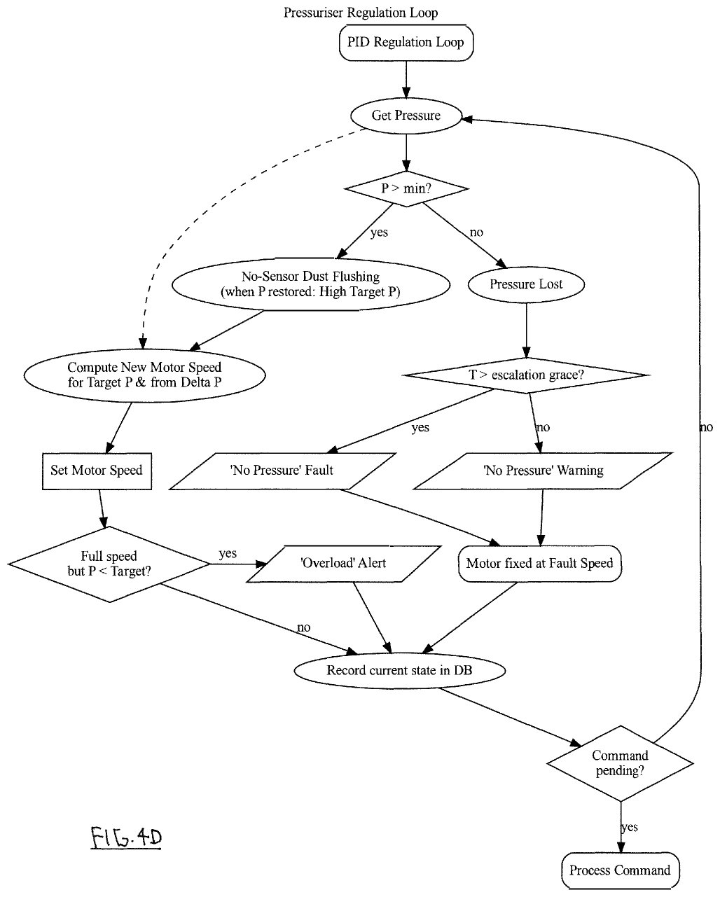

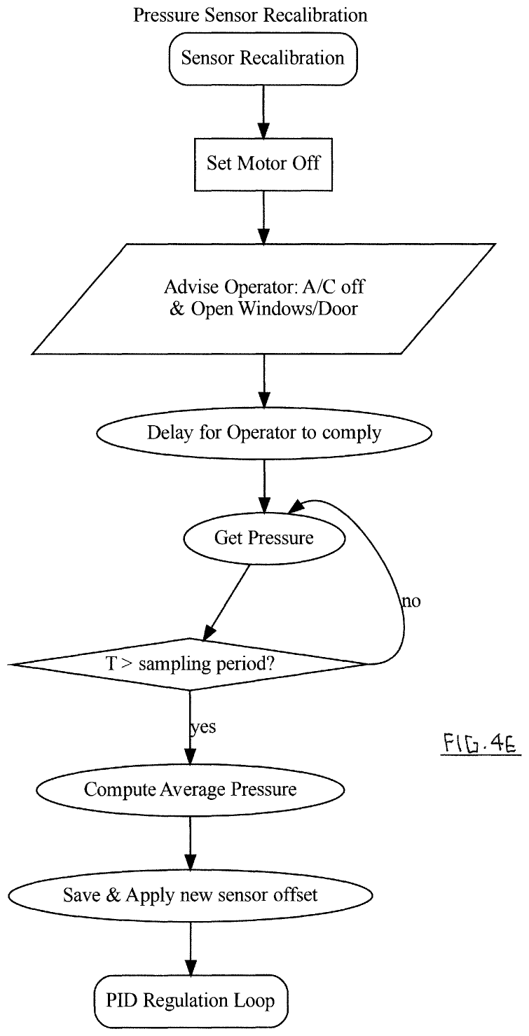

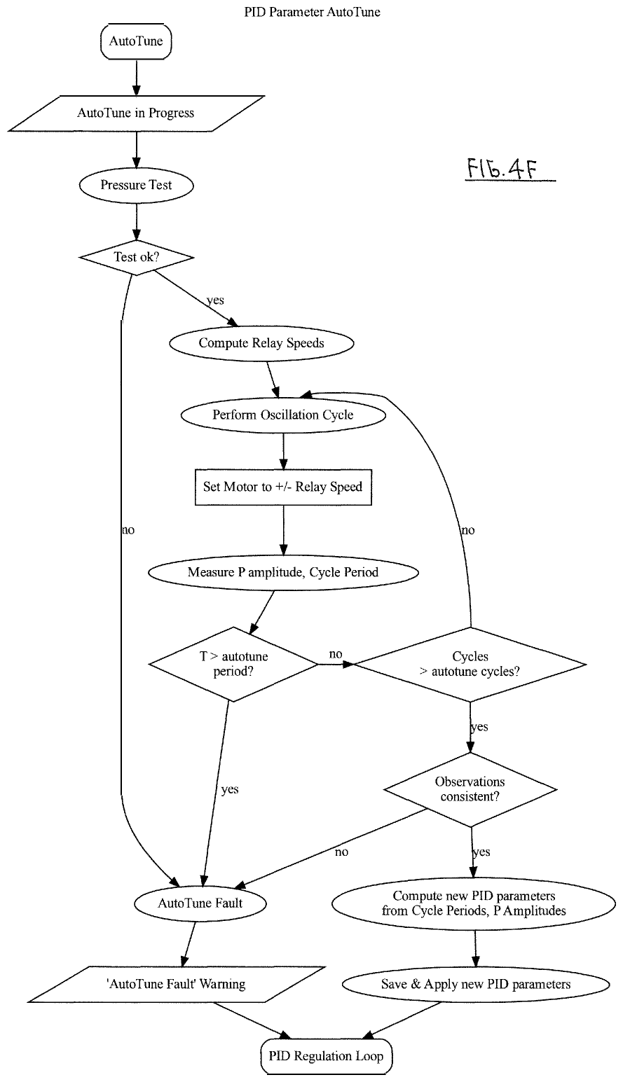

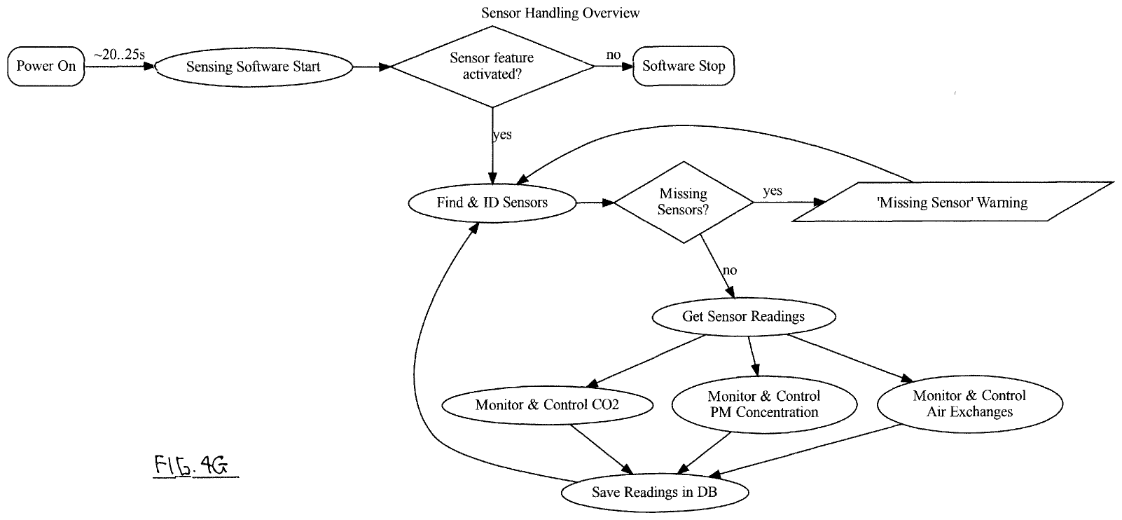

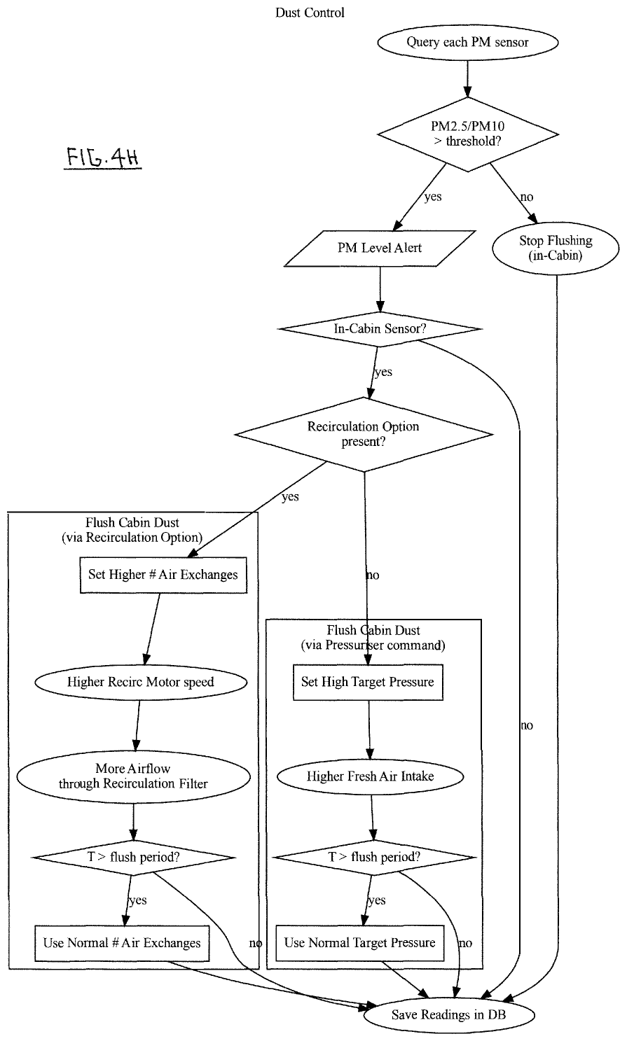

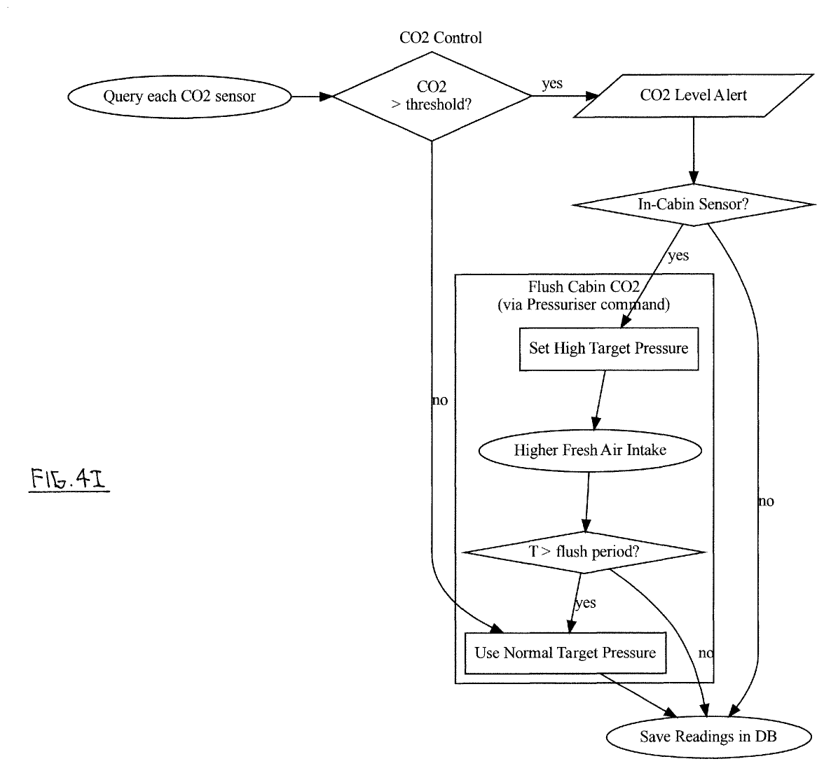

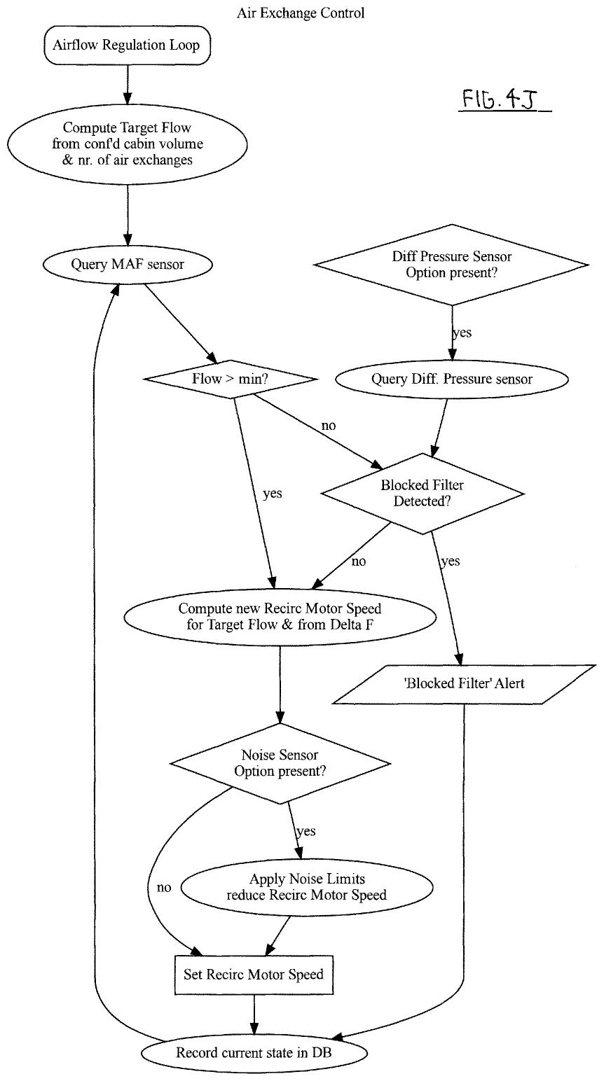

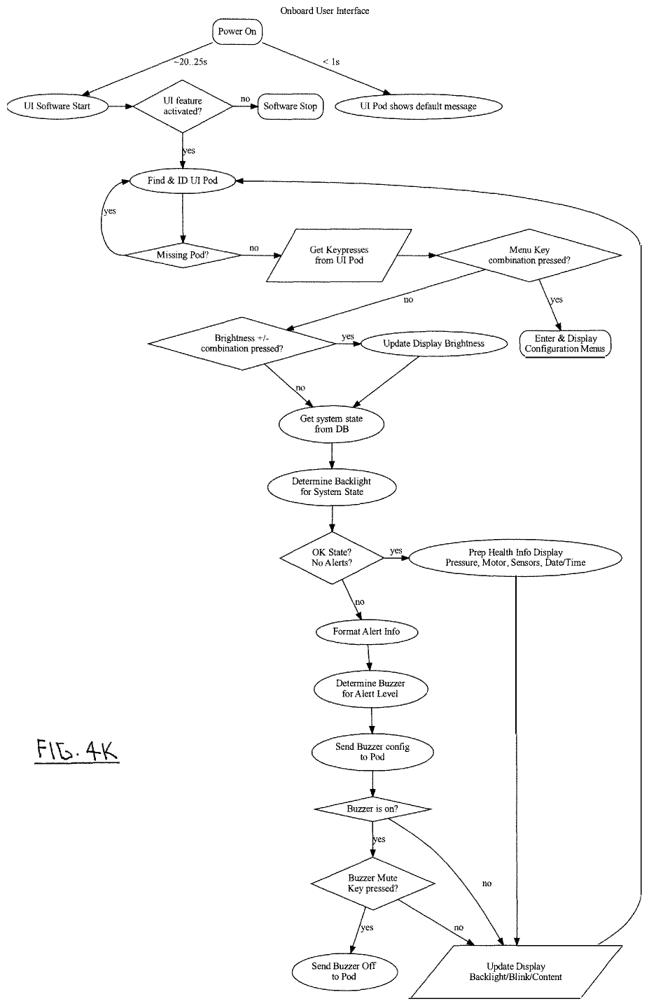

If the controller 10 receives a signal from a dust sensor 14 that indicates that the dust level in the enclosed space 20 has risen above the predetermined dust value, the controller 10 sends a signal to the respective motor of the air filtration unit 20 and/or the air pressuriser 18 to increase the speed of the respective motor to thereby increase the speed of the respective fan or impeller of the air filtration unit 20 and/or the air pressuriser 18. In FIG. 4H, this is represented by the parallelogram “PM Level Alert” being triggered if the particulate mass detected by a dust sensor 14 exceeds the configured dust threshold, which is represented in FIG. 4H by the diamond “PM 2.5/PM 10>threshold?”.

In FIG. 4H, increasing the speed of the motor of the air filtration unit 20 is represented by the steps in the box “Flush Cabin Dust (via Recirculation Option)”. Increasing the speed of the motor of the air filtration unit 20 draws more air from within the enclosed space 200 through the air filtration unit 20. This causes more air to be filtered by the filter of the air filtration unit 20. That is to say, the rate of filtration of the air by the filter of the air filtration unit 20 increases.

Increasing the rate of filtration by the filter of the air filtration unit 20 removes more dust from the air in the enclosed space.

Once the controller 10 receives a signal from the dust sensor 14 that the dust level has fallen below the predetermined value (i.e. the steady state condition for the dust parameter), the controller 10 sends a signal to the motor of the air filtration unit 20 to decrease the speed of the motor to thereby decrease the speed of the fan or impeller of the air filtration unit 20 to reduce the amount of air flowing (i.e. rate of airflow) through the air filtration unit 20.

If the signals that the controller 10 receives from the dust sensor/s 14 indicates that the dust level is in accordance with the predetermined value or is within the predetermined value range, the output signal issued by the controller 10 directs the motor of the air filtration unit 20 to maintain the current motor speed, i.e. the speed of the motor remains unchanged.

In addition, or alternatively, if the controller 10 receives a signal from a dust sensor 14 that indicates that the dust level in the enclosed space 20 has risen above the predetermined value the controller 10 may send a signal to the motor of the air pressuriser 18 to increase the speed of the motor of the air pressuriser 18. In FIG. 4H, increasing the speed of the motor of the air pressuriser 18 is represented by the steps in the box “Flush Cabin Dust (via Pressuriser command). Increasing the speed of the motor of the air pressuriser 18 increases the speed of the fan or impeller of the air pressuriser 18. This results in an increase in the volume of air flowing through the air pressuriser 18 into the enclosed space 200 inside the cabin 202. This results in the air pressure rising in the enclosed space 200 inside the cabin 202 which may assist in forcing air out of the enclosed space 200 through any gaps in the cabin 202. The air forced out through any gaps may also carry dust entrained in the air, and that air is replaced with filtered air from the air pressuriser 18. In this way the action of the operation of the air pressuriser 18 acts to flush out the dust with the air.

Once the controller 10 receives a signal from the dust sensor 14 that the dust level has fallen below the predetermined value (i.e. the steady state condition for the dust parameter), the controller 10 sends a signal to the motor of the air pressuriser 18 to decrease the speed of the motor to thereby decrease the speed of the fan or impeller of the air pressuriser 18 to reduce the amount of air flowing (i.e. rate of airflow) through the air pressuriser 18.

The system 1 may be configured, as required, to adjust the speed of the motor of the air pressuriser 18, air filtration unit 20, or both. Adjusting the speed of the motors of both the air filtration unit 20 and the air pressuriser 18 may be advantageous under some conditions. In one example, if the dust level in the enclosed space 200 is sensed by the dust sensor/s 14 to be relatively high, it may be advantageous to increase the speed of the motors of both the air filtration unit 20 and the air pressuriser 18. In another example, if the filter of the air filtration unit 20 is relatively loaded with dirt, the airflow through the filter would be less than the airflow if the filter was a new clean filter. Under such conditions, it may be advantageous to also increase the speed of the motor of the air pressuriser 18 (in addition to increasing the speed of the motor of the air filtration unit 20) to supplement the filtering action arising from the increased speed of the air filtration unit 20. However, if the conditions do not require an increase in the speed of the motors of both the air filtration unit 20 and the air pressuriser 18, then an increase in the speed of the motor of only the air filtration unit 20 may be sufficient to return the dust level in the enclosed space 200 to below the predetermined value. This option is represented in FIG. 4H which shows that, at the “Recirculation Option present?” diamond, the “Flush Cabin Dust (via Recirculation Option)” is selected (“yes” sequence from “Recirculation Option present?”) if the air filtration unit 20 is available; on the other hand, the “Flush Cabin Dust (via Pressuriser command)” is selected (“no” sequence from “Recirculation Option present?” for selection of the air pressuriser 18) if the air filtration unit 20 is not available.

### CO₂ Monitoring

Each CO₂ sensor 16 is in operative communication with the controller 10. Each CO₂ sensor 16 provides input signals to the controller 10 in relation to the CO₂ level in the enclosed space 200.

The system 1 operates to maintain the CO₂ level in the enclosed space 200 below a predetermined value (i.e. predetermined CO₂ value). FIG. 4I shows the control process for the CO₂ sensor/s 16 in the system 1.

The controller 10 may be responsive to an input signal from a CO₂ sensor by adjusting the speed of the motor (and thereby adjust the speed of the associated fan or impeller) of the air pressuriser 18 in the manner as herein before described, mutatis mutandis, with reference to pressure monitoring, except that the relevant predetermined value would be the predetermined CO₂ value and not the predetermined pressure value.

Accordingly, for example, if the controller 10 receives an input signal from a CO₂ sensor 29 that indicates that the CO₂ level in the enclosed space 200 has exceeded the predetermined CO₂ value, the controller 10 generates and sends an output signal to the motor of the air pressuriser 18 to increase the speed of the motor. The steps then undertaken are shown in the box “Flush Cabin CO₂” in FIG. 4I. Increasing the speed of the motor increases the speed (of rotation) of the fan or impeller that is driven by the motor of the air pressuriser 18. Increasing the speed of rotation of the fan or impeller increases the volume of fresh airflow through the air pressuriser 18 into the enclosed space 200. This increase in the fresh airflow into the enclosed space 200 flushes CO₂ from the enclosed space, thereby diluting the concentration of CO₂ in the enclosed space 200. After the controller 10 receives an input signal from the sensor 29 that indicates that the CO₂ level in the enclosed space 200 no longer exceeds the predetermined CO₂ value, the controller 10 generates and sends an output signal to the motor of the air pressuriser 18 to decrease the speed of the motor. This reduces the speed of rotation of the fan or impeller and returns the fresh airflow through the air pressuriser 18 to a normal level. This is shown in the box “Use Normal Target Pressure” in FIG. 4I.

The CO₂ sensors 16 may have barometric calibration. Barometric calibration of the CO₂ sensors 16 compensates for changes in altitude. This improves the accuracy of the readings of the CO₂ sensors 16.

### Other Gases Monitoring

Each (other) gas sensor 24/26 is in operative communication with the controller 10. Each gas sensor 24/26 provides input signals to the controller 10 in relation to the relevant gas level in the enclosed space 200.

The system 1 operates to maintain the gas/es level in the enclosed space below a predetermined value for the particular gas being monitored (i.e. predetermined gas value).

The controller 10 may be responsive to an input signal from a gas sensor 24/26 by adjusting the speed of the motor (and thereby adjust the speed of the associated fan or impeller) of the air pressuriser 18 in the manner as herein before described, mutatis mutandis, with reference to CO₂ monitoring, except that the relevant predetermined value would be the predetermined gas value and not the predetermined CO₂ value.

### Airflow Monitoring

Each airflow sensor 36 is in operative communication with the controller 10. Each airflow sensor 36 provides input signals to the controller 10 in relation to the airflow at the location of the airflow sensor 36.

The system 1 operates to maintain the airflow in the enclosed space 200 above a predetermined value (i.e. predetermined airflow value). This ensures that the desired levels of fresh filtered air from the air pressuriser 18 and recirculated filtered air from the air filtration unit 20 are delivered into the enclosed space 200.

Having an airflow sensor 36 at the filtered air outlet 19 of the air pressuriser 18 enables the airflow in or into the enclosed space 200 to be monitored. Having a second airflow sensor 36 at the outlet 20b of the air filtration unit 20 enables the airflow from the air filtration unit 20 in or into the enclosed space 200, i.e. the airflow of filtered air into the enclosed space 200, to be monitored.

The controller 10 may be responsive to an input signal from an airflow sensor 36 by adjusting the speed of the motor (and thereby adjust the speed of the associated fan or impeller) of the air filtration unit 20 or the air pressuriser 18 or both in the manner as herein before described, mutatis mutandis, with reference to dust monitoring. The relevant predetermined value would be the predetermined airflow value and not the predetermined dust value.

The readings that the controller 10 receives from the sensors may be recorded in a data store. The data store can be accessed to analyse the readings data and fluctuations of the environmental parameter/s.

Furthermore, the readings that the controller 10 receives from the air flow sensor/s 36 may be used as a diagnostic or monitoring tool (or aid) to determine filter life (of the filters in the air pressuriser 18 and air filtration unit 20) and/or when a filter is fully loaded (i.e. blocked) and needs to be replaced.

### Sound Monitoring

The sound sensor 28 monitors the sound levels (i.e. decibel levels) in the enclosed space 200. As with the other sensors in the system 1, the readings from the sound sensor 28 are stored in the data store and can be accessed for analysis. For example, analysis of the sound readings from the sound sensor 28 provides information about the levels of sounds to which the operator is exposed whilst in the enclosed space 200 of the vehicle cabin 202. In the event that the sound levels are found to be excessive, steps can be taken to reduce the excessive sound levels.

### Vibration Monitoring

The vibration sensor 29 monitors the vibration levels in the enclosed space 200. As with the other sensors in the system 1, the readings from the vibration sensor 29 are stored in the data store and can be accessed for analysis. For example, analysis of the vibration readings from the vibration sensor 29 provides information about the levels of vibration to which the operator and/or equipment is/are exposed in the enclosed space 200 of the vehicle cabin 202. In the event that the vibration levels are found to be excessive, steps can be taken to reduce the excessive vibration levels.

### Temperature and Relative Humidity

Since the temperature and relative humidity in the enclosed space 200 of the cabin 202 are typically controlled by the HVAC system 208, these environmental parameters are not controlled by the system 1. However, monitoring such environmental parameters (using the temperature sensor 30 and the relative humidity sensor 31) enables the readings from these sensors to be recorded in the data store. Consequently, these data readings are accessible to analyse the data readings and fluctuations of these environmental parameter/s.

### Operation

The system 1 operates in the manner herein before described with particular reference to the operation of the various sensors. The sensors are constantly monitoring the enclosed space 200 and sending input signals to the controller 10 with their respective readings. The sensors operate at different sampling frequencies to take their readings depending upon their respective capabilities. For example, the sampling cycle of a pressure sensor 12 may be 8 Hz (but may support up to 1 kHz), the dust cycle may support 1 Hz and the CO₂ sensor 0.5 Hz.

The controller 10 sends output signals to the motor of the air pressuriser 18 and/or air filtration unit 20 based on whether the controller 10 determines that the input signals received from the sensors require adjustment to the speed of the motor/s.

On start-up (i.e. power-on) of the system 1, an automatic pressure test is undertaken to test system serviceability, as shown in the process flow diagram in FIG. 4C which is further described herein. The pressure test staggers pressure build-up by the air pressuriser 18 in the enclosed space 200 of the cabin 202 to a test target pressure (i.e. set point pressure), e.g. 300 Pa.

The system 1 is also able to detect a no-pressure or loss-of-pressure condition in the enclosed space 200 of the cabin 202. This can occur, for example, if a window or door of the cabin 202 is left open or opened or possibly if there is complete failure of a particular cabin seal. In such a situation, the controller 10 receives an input signal from the pressure sensor 12 indicating that a no-pressure or loss-of-pressure condition has occurred. If the controller 10 determines that the pressure sensed by the pressure sensor 12 indicates that the pressure in the enclosed space 200 has fallen below a predetermined level, this triggers a no-pressure/loss-of-pressure condition fault state; this is represented in FIG. 4C by the bubble “Fault State”. The predetermined level may be adjustable and selected to suit different environments. For example, small cabins that can be readily sealed effectively would be expected to have a relatively high target set point pressure, high pressure loss threshold (i.e. a significant pressure loss must occur to trigger the alert) whilst large, poorly sealed rooms would be expected to have a relatively low target set point pressure, minimal loss threshold (i.e. small pressure loss would trigger the alert). For increased robustness in the case of pressure sensor aging, sensor drift, sensor miscalibration, wind effects etc., the predetermined level is always slightly above 0 Pa so that an alert is raised even if the pressure sensor is offset slightly or reading slightly above 0. Upon receiving a signal from the pressure sensor 12 indicating that a no-pressure or loss-of-pressure condition has occurred, the controller 10 sends an output signal to the motor of the air pressuriser 18 to reduce the speed of the motor down to a predetermined fault speed; this is represented in FIG. 4C by the bubble “Motor fixed at Fault Speed”. The predetermined fault speed is a reduced speed. This avoids the motor of the pressuriser 18 running at full (or very high) speed, with the window or door open or other ongoing fault condition, for no or very little beneficial result in air quality in the enclosed space 200 of the cabin 202. The motor of the pressuriser 18 will continue to run at the reduced fault speed (i.e. fault speed mode) whilst the pressure sensor 12 continues to sense that the no-pressure or loss-of-pressure condition exists. Once the open window or door is closed or other fault corrected, the pressure sensor 12 will sense the build-up in pressure inside the enclosed space 200. This build-up in pressure sensed by the pressure sensor is communicated to the controller 10 by the pressure sensor 12. The controller 10 then sends an output signal to the motor of the air pressuriser 18 that indicates that the no-pressure or loss-of-pressure condition has ceased. The motor of the air pressuriser 18 exits the fault speed mode and operates as normal. Should the motor of the air pressuriser 18 run at full or very high speed in such a situation, the result may be a significant reduction in the service-life of the filter of the air pressuriser 18, which can be a costly item to replace. Accordingly, detecting a no-pressure/loss-of-pressure condition and undertaking action in response to the detection of that condition as herein before described has the beneficial effects of preventing unnecessary loading on the motor of the air pressuriser 18. This increases the lifespan of the motor and also improves the operating economy of the motor.

The system 1 may provide automatic volume control of the motor of the air filtration unit 20. This prevents the motor of the air filtration unit 20 ramping up to full speed as the sound/noise level would be undesirable for the operator in the cabin 202. Thus, the controller 10 will send a signal to prevent the speed of the motor of the air filtration unit 20 increasing further once the sound emitted by the motor reaches a predetermined sound value (i.e. predetermined decibel level). This can be achieved by having the sound sensor 28 monitor the sound levels coming from the air filtration unit 20. The sound sensor 28 sends input signals of the sensed sound levels to the controller 10. If the controller 10 determines that an input signal from the sound sensor 28 indicates that the sound level emitted by the motor of the air filtration unit 20 is excessive (i.e. the sound level exceeds a predetermined sound level), the controller 10 then sends an output signal to the motor of the air filtration unit 20 to reduce the speed of the motor such that the level (i.e. volume) of the sound emitted by the motor is reduced to below the predetermined decibel level).

The system 1 may use the (motor control industry-standard) PID control principle, i.e. it employs proportional-integral-derivative feedback control: the current error (=difference between target input and measured input) is computed continuously and used (with three configurable factors) to calculate a motor speed correction.

These factors govern the reaction of the system 1 to disturbances and can be autodetected for a given combination of cabin volume, cabin sealing quality, ducting lengths, motor ramp speeds etc. using a variety of (motor control industry-standard) heuristics, or manually set using the configuration settings available via the web interface hereinbefore described. Depending on the choice of factors, reaction to disturbances can be almost instantaneously (but slightly oscillatory) or slow (but with little to no overshooting).

The system 1 may include various capabilities. In that regard, on-board telemetry access and telemetry visualisation using a browser: as hereinbefore described, a (self-contained) web interface may be provided, which allows access to the complete telemetry database and offers selective exporting of data of various types and ages, in form of csv aka ‘comma-separated values’ files that plug straight into standard spreadsheet applications. Telemetry data can also be viewed and optionally followed live with the onboard chart viewer, which provides flexible selection of time ranges and telemetry sources to be charted. Flexible high-level data access for integration into customer management systems may be provided: the onboard web interface may provide an effective yet simple way to poll telemetry data, but other tcp- or udp-based transport mechanisms can be added with little effort; typical data formats like json, xml or csv are supported out of the box and other formats can be added easily.

### Process Flow Diagrams

In FIGS. 4A to 4K, there are shown embodiments of process flow diagrams of technical operational processes of the system 1 shown in FIGS. 1A, 1B, 2 and 3. Some of these have been herein before described.

FIG. 4A shows the power-on sequence of the system 1.

Upon initiation of power-on, the single board computer of the controller 10 of the system 1 may take a few seconds to start. However, to alleviate this delay, the system hardware and firmware may produce limited operation immediately after power-on: the user interface pod 42 may present a welcome/start-up message, the motor of the pressuriser 18 starts up with the most recently saved motor speed, and sensor pods 22, 22a-22d command the various sensors to initialise themselves as soon as possible. These types of operations are shown in the four bubbles under the “Power On” bubble in FIG. 4A.

Following the start of the operating system, various start steps are undertaken as represented in FIG. 4A by the first row of bubbles, including the control software start, sensing start (of the sensors), the database exporter start (to export operation data to the database) and the web interface start. Licence checks and enforcement may also be performed, following collection of the device identifiers, as represented in FIG. 4A by the bubble “Collect Device Identifiers” and the diamond “Licence Checks?”. Typically, such checks are performed by the controller 10, with a view to putting in place an impediment to extract and run the system control software on unofficial or unauthorised platforms. Enforcement may use a combination of hardware-level invariant identifiers and (relatively hard to change) embedded data, with a keyed HMAC (hash-based message authentication code), to tie this system software instance to that particular (bespoke) system electronics shield and that particular single board computer. If no licence or if an invalid licence is encountered, the pressuriser 18 changes to minimal operation mode, e.g. it configures the motor of the pressuriser 18 to the fixed fault speed and raises a ‘no licence’ alert; this is represented in FIG. 4A by the parallelogram “No Licence Alert” and the bubble “Motor at Fixed Speed”. This in turn instructs all other software components of the system to refuse access to the end-user. On the other hand, a valid licence results in normal access and operation of the system, resulting in the next step being for the pressure to rise to the normal level; this is represented in FIG. 4A by the bubble “Wait for Pressure”.

FIG. 4B shows the states and transitions of the controller 10.

The controller 10 transitions through a sequence of states, or steps, while the system 1 is powered-up. The controller 10 normally spends most of the time in the “PID regulation loop’” (as shown in that bubble in FIG. 4D). All available state and telemetry data for the system may be saved in a database, such as the data store herein before described, regardless of operational state of the controller 10.

In some environments, waiting for positive pressure is not feasible (e.g. in environments in which the system 1 has to overpower an external air pressuriser 18). In such situations, the “Wait for Pressure” state (represented by that bubble in FIG. 4B) may be disabled. If the “Wait for Pressure” state is disabled, the state of the controller 10 (i.e. the controller state) transitions directly from the “Ctrl Software Start” state (i.e. Control Software Start state) to the “Pressure Test” state. This transition is shown by the dashed broken line in FIG. 4B.

In situations in which the “Wait for Pressure” state is not disabled, the controller 10 transitions through the states shown by the dashed and dotted broken lines shown in FIG. 4B. In this transition sequence, the controller 10 transitions from the “Ctrl Software Start” state to the “No Pressure Fault” state and then to the “Pressure Test” state. This transition sequence ensures that a pressure test is always performed during start-up—even if the operator leaves the door/windows open for too long and the system 1 goes through a no-pressure fault period. In such circumstances, the pressure test sequence is started once pressure is detected for the first time.

FIG. 4C shows the steps in the pressure test performed by the system 1.

The start sequence provides a balance aimed at relative simplicity, ease of use and safety, while still avoiding unnecessary consumption of consumables (e.g. the filters in the air pressuriser 18, the air filtration unit 20 and the filter 218 of the HVAC system 208).

The motor of the air pressuriser 18 pressuriser is normally running at all times that the system 1 is powered-on. This aims to ensure that there is always at least some positive pressure in the enclosed space 200 of the cabin 202.

On start-up, the controller 10 may await pressure build-up (for a configurable start-up grace period of time); this is represented by the “Wait for Pressure” bubble in FIG. 4C. This allows for the operator of the vehicle settling in place, doors and windows being closed and similar actions. If pressure is detected, a pressure test sequence starts which detects the current relationship between the speed of the motor of the air pressuriser 10 and effective air pressure in the enclosed space 200. The data of the relationship between the motor speed of the air pressuriser 10 and effective air pressure in the enclosed space 200 is stored in a database. Analysis of this data over time can be used to determine various events, e.g. filter and seal performance: end of filter life-time (e.g. the filters in the air pressuriser 18, the air filtration unit 20 and the filter 218 of the HVAC system 208) and degradation of seals of the cabin 202. For example, over time it can be expected that the filters will become loaded with dust and dirt particles. This loading will gradually restrict airflow through the filters. Over time this may lead to the motor of the air pressuriser 18 having to operate at higher speeds to maintain the same level of effective air pressure in the enclosed space 200 or may lead to a drop in the effective air pressure in the enclosed space 200. Analysis of the relationship data, over time, between the motor speed of the air pressuriser 10 and effective air pressure in the enclosed space 200 can be used to identify end of filter life-times indicating the need for filter replacement. Similarly, if the relationship data between the motor speed of the air pressuriser 10 and effective air pressure in the enclosed space 200 shows that the effective air pressure in the enclosed space 200 has fallen even though the motor is operating at the same or a higher speed, this may indicate that air is leaking from the enclosed space 200. This would suggest that the cabin 202 has been punctured or that some of the seals of the cabin 202 have degraded and are longer effectively sealing the cabin 202. Once the fault has been identified, corrective steps can be taken to remedy the fault.

During the pressure test, commanded motor speeds of the air pressuriser 18 are ramped up to stagger pressure build-up until a configurable test target pressure (i.e. set point pressure) is reached, e.g. 300 Pa, (or until full speed is reached, or beyond the time for a test timeout); this is represented in FIG. 4C by the diamonds “PT Target reached?” and “T>test timeout?”. For each speed, the controller 10 uses a short delay to detect when pressure has steadied (as the motor speed does not ramp up instantaneously). The steady pressure condition is represented in FIG. 4C by the diamond “P steady?”. The pressures achieved and the corresponding speeds of the motor of the air pressuriser 18 may be logged and stored in the data store.

If the pressure test does not complete successfully, a test failure alert is generated; this is represented in FIG. 4C by the parallelogram “‘Test Fault’ Warning”. Like all alerts, it is displayed on the user interface pod 42 (if one is configured and present) and it is logged in the database (i.e. data store). Some alerts (such as, for example, a test failure alert) are typically configured to expire automatically after an elapsed time period.

FIG. 4D shows the regulation loop for the air pressuriser 18.

The controller 10 may employ a standard PID control loop, (i.e. proportional/integral/derivative of the error of the process variable [i.e. pressure] is used to adjust the control variable [i.e. motor speed] to maintain the configurable desired target pressure by adjusting the speed of the motor of the air pressuriser 18).

The controller 10 may, however, apply PID control only if feasible and desirable: for example, if the pressure falls below a configurable minimum loss-of-pressure threshold; this is represented in FIG. 4D by the “no” sequence leading from the diamond “P>min?” (i.e. pressure greater than the minimum pressure). In a loss of pressure condition, the controller 10 switches to a predetermined static fixed fault speed, as shown at the state identified by the bubble as “Motor fixed at Fault Speed” in FIG. 4D. The aim of this change of mode is to avoid unnecessarily loading filters when there is no prospect of achieving positive pressure, e.g. when a door or window of the cabin 202 is wide open.

Pressure readings may be taken multiple times per second. A rolling window average may be used to filter out sensor noise.

In the case of a pressure loss, the controller 10 enters a fault state and a “‘No Pressure’ Warning” is raised at first, as indicated in the corresponding parallelogram in FIG. 4D; the start time of the fault may be marked and recorded. If positive pressure returns, the warning is cancelled and normal PID regulation resumes immediately. If, however, the fault persists beyond the escalation grace period (represented in FIG. 4D by the diamond “T>escalation grace?”), then the warning is escalated to a ‘no pressure’ alarm; this is represented in FIG. 4D by the parallelogram “‘No Pressure’ Fault”. This two-stage alert protocol (i.e. an initial “warning” which is escalated to an “alarm” only if the pressure fault persists) is beneficial as it is able to handle temporary disruptions to the pressurisation state of the enclosed space 200 of the cabin 202 (e.g. a briefly opened cabin window or door) and avoid issuing alerts that may not actually be necessary, which could distract the equipment operator. This two-stage alert protocol confirms that the loss of pressure condition is persistent before issuing a ‘no pressure’ alarm; the ‘no pressure’ alarm indicates that remedial action may be required to remedy the ‘no pressure’ condition. Furthermore, the system 1 may also optionally be configured to delay the raising of the “‘No Pressure’ Warning” for a selected period of time, e.g. a short delay period. If this delay is configured, the “‘No Pressure’ Warning” will not be raised until the pressure loss condition has persisted for at least this delay period. This further reduces alerts being raised due to temporary disruptions, e.g. in environments where external factors can introduce extra noise that affects the pressure sensor 12 (for example, an installation that is subject to both strong, variable winds and running with a low target setpoint pressure).

All alerts of the system 1 may be configurable in terms of, for example, severity, alert text to display, and audio-visual behaviour for the alert. A no pressure warning may be configured with less severe alerting options than a no pressure alarm (e.g. yellow display backlight and no buzzer, versus red and loud buzzer, respectively).

Provision may be made such that the pressure loss logic can be bypassed completely by setting suitable configuration options. This transition sequence is shown by the dashed broken line in FIG. 4D. In this transition sequence, the system 1 transitions directly from the “Get Pressure” state bubble in FIG. 4D (i.e. the current pressure generated by the air pressuriser 18) to the “Compute New Motor Speed for Target P (Pressure) & from Delta P (Pressure)” bubble in FIG. 4D. This may be desirable in environments where no human operator is involved and the enclosed space is sealed, essentially permanently (e.g. electrical cabinets). Without a human to open windows or doors, the likelihood of spurious pressure loss events is usually very low and thus always running up to and including full speed of the motor of the pressuriser 18 is preferable over using a reduced fault speed.

In the event that the motor of the air pressuriser 18 is running at or near its full speed and the pressure sensed inside the enclosed space 200 is below a predetermined (configurable) value, e.g. a fraction or percentage of the target pressure setpoint, an ‘Overload’ alert is raised (as signalled by the controller 10) when this condition persists for a predetermined (and configurable) period of time; this is represented in FIG. 4D by the diamond “Full speed but P<Target?” and the parallelogram “‘Overload Alert”. The ‘Overload’ alert indicates that the motor of the air pressuriser 18 has insufficient capacity to reach the target set point pressure (and is therefore being overloaded). This typically indicates that either a component of the sealing of the cabin 202 has failed and there is significant leakage of air from the enclosed space 200 or that the filter of the air pressuriser is loaded (with dust and dirt particles) and needs to be replaced. A benefit of the ‘Overload’ alert feature is that it is performed continuously. Therefore, the system 1 does not have to rely solely on the automatic pressure test (herein described), which is performed only at system start-up, to detect end of filter life.

The controller 10 may also periodically query the database (data store) for externally triggered commands to process.

FIG. 4E shows the recalibration process for the pressure sensor/s.

The system 1 may also provide pressure sensor recalibration (or re-zero) functionality. This is useful if the particular pressure sensor 12 that is used has a tendency, albeit slight, to drift over time and/or if abused, resulting in an undesirable offset zero point. Pressure sensor recalibration may be provided as a user-initiated function.

The recalibration may be triggered from the user interface 42 or the web interface. This is performed by the controller 10 (as an externally triggered command) and entails switching off the motor of the air pressuriser 18 (represented in FIG. 4E by the “Set Motor Off” box) and instructing the operator switch off the air conditioning system and to open doors or windows (represented in FIG. 4E by the parallelogram “Advise Operator: A/C off & Open Windows/Door”). A time period is allowed for the operator to perform these actions (represented in FIG. 4E by the bubble “Delay for Operator to comply”). After the time period has elapsed, it is followed by a configurable period of pressure readings (represented in FIG. 4E by the bubble “Get Pressure” and the diamond “T>sampling period” loop) which are finally averaged (represented in FIG. 4E by the bubble “Compute Average Pressure”) and saved as the new zero offset for the pressure sensor 12 (represented in FIG. 4E by the bubble “Save & Apply new sensor offset”). The process then moves to the PID Regulation Loop”, as shown in FIG. 4E.

FIG. 4F shows the PID parameter auto tune.

The controller 10 may employ a standard PID control loop. The standard PID control loop may require three gain parameters to operate satisfactorily (i.e. with rapid convergence but limited overshoot or hunting behaviour). The unit may be shipped with reasonable defaults, but environmental changes may make these defaults less than ideal.

The autotune function automatically generates new PID gain values by inducing oscillations and measuring the control loop behaviour (aka relay or Astroem-Haegglund method). An autotune setpoint is sourced from the configuration file. An initial pressure test (represented in FIG. 4F by the bubble “Pressure Test”) provides two coarse relay speeds (represented in FIG. 4F by the bubble “Compute Relay Speeds) that correspond to pressure somewhat below and above that test setpoint, respectively. Switching between those relay speeds results in oscillations (represented in FIG. 4F by the bubble “Perform Oscillation Cycle”). The period and maximum amplitude of the oscillations may be measured (represented in FIG. 4F by the bubble “Measure P amplitude, Cycle Period”).

After performing a configurable number of cycles (represented in FIG. 4F by the diamond “Cycles>autotune cycles?”), the system 1 checks that there are sufficient consistent measurements (represented in FIG. 4F by the diamond “Observations consistent?”). This is advantageous because PID controllers can become unstable if the gain parameters are unsuitable. Potentially, this could lead to undampened pressure oscillations. If safe to do so, the oscillation measurements may be used to compute new PID gain values (represented in FIG. 4F by the bubble “Compute new PID parameters from Cycle Periods, P Amplitudes”). This may be done using one of seven common parameter derivation heuristics (e.g. ‘Pessen Integral Rule’ or ‘Ziegler-Nichols’). The new PID parameters are saved and applied (represented in FIG. 4F by the bubble “Save & Apply new PID parameters”). The process proceeds to the PID regulation loop.

As shown in FIG. 4F, should an autotune fault be detected (represented in FIG. 4F by the bubble “AutoTune Fault”), a fault warning is generated (represented in FIG. 4F by the parallelogram “‘AutoTune Fault Warning”). Appropriate steps can then be undertaken to remedy the fault.

FIG. 4G shows an overview of the handling process for a sensor of the system 1.

The pressure sensor 12 in the system 1 may be an ultra-low pressure differential pressure sensor. This sensor is queried mostly by the controller 10. Other software components may typically access pressure readings indirectly via the in-memory database (date store).

A variety of external other sensors can be connected to the controller 10 of the system 1. The controller 10 may be provided with expansion ports for this purpose. External sensors (and the keypad/buzzer/display unit) may use a custom pod design, e.g. a single cat5 twisted pair cable may provide both power to the podded hardware and an rs485 bus for communication; a microcontroller in each pod may serve as protocol translator and exposes various pod type identifiers and a unique pod serial number.

Any podded external sensors may be handled by a dedicated sensing software component. However, because external sensors can be disconnected, the sensing component has to track and identify which sensors are present; this may be checked whenever necessary (e.g. when a pod suddenly has become unresponsive or was moved to a different expansion port).

After power on, some initial check steps are performed to check that the sensors are activated and responsive. This is represented by the bubble “Sensing Software Start” and the diamond “Sensor feature activated?”. Should these checks fail, a “Software Stop” warning is issued, indicating that corrective action is required. On the other hand, a positive outcome to the initial checks, results in the identification of the sensors (represented in FIG. 4G by the bubble “Find & ID Sensors”). If any sensors are not located, a “‘Missing Sensor’ Warning” is issued, indicating that corrective action is required. Provided that there are no sensor warnings, the controller 10 periodically collects the readings of all configured sensors and saves these in the database (i.e. data store). This is represented in FIG. 4G by the bubble “Get Sensor Readings”, the three bubbles on the next row, namely “Monitor & Control CO₂”, “Monitor & Control PM Concentration” and “Monitor & Control Air Exchanges” and ending in the bubble “Save Readings in DB”.

The controller 10 may also analyse the readings of the sensors to detect unsafe or undesirable situations. In the event that an unsafe or undesirable situation is detected, an alert may be raised. Some situations may change the behaviour of the controller 10. For example, if high CO₂ concentrations are detected by a CO₂ sensor 14, the controller 10 issues a signal to the motor of air pressuriser 18 to temporarily increase the intake of fresh air to flush the CO₂. A mass airflow sensor 36 allows additional faults to be detected, e.g. a blocked filter or motor faults.

FIG. 4H shows the control process for the dust sensor/s 14, as herein before described.

FIG. 4I shows the control process for the CO₂ sensor/s 16, as herein before described.

FIG. 4J shows the air exchange control process for the air recirculation unit 20.

The target airflow through the air recirculation unit is determined. This may be done, for example, from the confirmed volume of the enclosed space 200 in the cabin 202 and the number of air exchanges of the air in the enclosed space over a given time period. This is represented in FIG. 4J by the bubble “Compute Target Flow from conf'd cabin volume & nr. of air exchanges”. If the signal from the airflow sensor 36, at the outlet 20b of the air filtration unit 20, (represented in FIG. 4J by the bubble “Query MAF sensor”, i.e. mass air flow sensor) indicates to the controller 10 that the airflow is greater than the (configurable) minimum airflow, a new speed is computed for the motor of the recirculation unit 20. This is represented in FIG. 4J by the diamond “Flow>min?” and the bubble “Compute new Recir Motor Speed for Target Flow & from Delta F”. (Delta F is the change in airflow caused by the adjustment of the speed of the motor of the air recirculation unit 20. For example, the increase in airflow that results from an increase in the speed of the motor of the air recirculation unit 20, or vice versa If a sound sensor 28 is provided to monitor the sound levels coming from the air filtration unit 20, sound (or “noise”) level limits may be applied before setting the speed of the motor in the air recirculation unit 20, which is represented in FIG. 4J by the box “Set Recirc Motor Speed”. The sound level check is represented in FIG. 4J by the diamond “Noise Sensor Option present” and the bubble “Apply Noise Limits reduce Recirc Motor Speed”. Applying sound level limits prevents the motor in the air recirculation unit 20 operating at speeds that would result in excessive noise in the enclosed space 200 of the cabin 202, which would make the enclosed space uncomfortable for an occupant. However, if such a sound sensor 28 is not provided for the air recirculation unit 20, the speed of the motor in the air recirculation unit 20 is set, as represented in FIG. 4J by the box “Set Recirc Motor Speed”. This is recorded in the database (represented in FIG. 4J by the bubble “Record current state in DB”).

In the event that the sensed airflow through the air recirculation unit 20 is lower than the (configurable) minimum airflow, this indicates a possibly blocked filter in the air recirculation unit 20. This is represented in FIG. 4J by the “no” sequence leading from the diamond “Flow>min?” to the diamond “Blocked Filter Detected?”. A blocked filter alert is issued (represented in FIG. 4J by the parallelogram “‘Blocked Filter Alert”), indicating that corrective action is required (i.e. replacement of the filter). This is recorded in the database (represented in FIG. 4J by the bubble “Record current state in DB”). In addition, a blocked filter may be detected following a query of a differential pressure sensor 12. This is represented in FIG. 4J by the diamond “Diff Pressure Sensor Option present?” (to confirm the presence of a differential pressure sensor 12) and the bubble “Query Diff. Pressure sensor”. If the signal from the differential pressure sensor 12 (or other pressure sensor 12) indicates to the controller 10 that the pressure generated at the outlet 20b of the air recirculation unit 20 has fallen to a (configurable) predetermined level or by a (configurable) predetermined amount, this may indicate that there is an impediment to airflow to the enclosed space 200. The impediment may be that the filter in the air recirculation unit 20 is blocked. Consequently, a “Blocked Filter Alert is issued”, indicating that corrective action may be required (i.e. replacement of the filter).

FIG. 4K shows the power-on sequence of the onboard user interface 42.

As herein before described, the user interface 42 may autonomously and immediately initialise the display to show a welcome message just after power-up. This message may remain visible until the operating system finishes booting and the software component of the user interface starts. The initialisation and booting steps are shown at the upper portion of FIG. 4K.

The backlight of the display 42 may be set according to system state and alert severity (if any), and includes controllable colour, brightness and blink behaviour. These features may be configurable using the web interface. The brightness of the display 42, for example, may be adjusted by the operator by pressing and holding certain keys on the keypad, and this brightness level may persist across restarts of the system 1.

The display 42 may provide a ‘traffic light’-style status indication, e.g. various shades of green for normal operation, yellow for out-of-nominal situations, and red for faults.

While the system 1 is in the normal state (i.e. no alerts or warnings are current), the user interface 42 may display various health information of the system 1, e.g. motor speed, pressure, sensor readings, time and date) in rotation. This is represented in FIG. 4K by the bubble “Prep Health Info Display Pressure, Motor, Sensors, Date/Time”.

In the event of one or more alert situations, process steps followed are shown in the “no” sequence leading from the “OK State? No Alerts” diamond in FIG. 4K. The alerts and their associated help text may be rotated on the display. The alert help texts may be configurable. Depending on the severity of an alert, the buzzer may also be activated to issue an audible alert to the operator. The buzzer tune and volume may be configurable. The ability to mute or cancel the buzzer for a particular alert may be configurable. If the configuration allows muting for a current alert, then the text shown may include a prompt for a particular keypress to mute the buzzer. This is represented by the “Buzzer Mute Key Pressed?” diamond in FIG. 4K. If pressed, the buzzer is switched off (represented by the “yes” sequence leading from the bubble “Send Buzzer Off to Pod” in FIG. 4K) and the muting action may be logged and remembered by the system 1 until the alert is cancelled.

Access to the configuration menus may be possible, e.g. by a combination of keypresses on the keypad. The configuration menus provide access to the configurable items in the system 1. The configuration menus may have different levels of access control.

Whilst one or more preferred embodiments of the present invention have been herein before described, the scope of the present invention is not limited to those specific embodiments, and may be embodied in other ways, as will be apparent to a person skilled in the art.

The individual features, structures or characteristics of each aspect or embodiment disclosed herein may each be combined with any or all features, structures or characteristics of the other aspects or embodiments. Furthermore, the particular features, structures or characteristics may be combined as suitable in one or more aspects or embodiments of the disclosure.

Modifications and variations such as would be apparent to a person skilled in the art are deemed to be within the scope of the present invention.

### Features

Various features and combinations of features disclosed herein are set out in the following paragraphs:
1. A system for monitoring and controlling environmental parameters in an enclosed space comprising
a controller,
at least first sensors to monitor environmental parameters inside the enclosed space, the sensors including
   at least one pressure sensor to sense the pressure inside and outside the enclosed space,
   at least one dust sensor to sense the presence of dust particles in the enclosed space,
   at least one CO₂ sensor to sense the presence of CO₂ in the enclosed space, and
wherein the controller and the first sensors are in operative communication such that, in use, the controller receives one or more input signals from the first sensors and in response to the input signals the controller is able to generate one or more output signals that are sent to an air pressuriser and/or an air filtration unit to control the operation of the air pressuriser and/or the air filtration unit to thereby control at least some environmental parameters relating to air quality inside the enclosed space.
2. A system for monitoring and controlling environmental parameters in an enclosed space comprising
a controller,
at least first sensors to monitor parameters indicative of air quality inside the enclosed space, the first sensors including
   at least one pressure sensor to sense the pressure inside and outside the enclosed space,
   at least one dust sensor to sense the presence of dust particles in the enclosed space,
   at least one CO₂ sensor to sense the presence of CO₂ in the enclosed space, and
an air pressuriser to filter and deliver air from outside the enclosed space into the enclosed space,
an air filtration unit to filter air within the enclosed space,
wherein the controller and the first sensors are in operative communication such that, in use, the controller receives one or more input signals from the first sensors and in response to the input signals the controller generates one or more output signals that are sent to the air pressuriser and/or the air filtration unit to control the operation of the air pressuriser and/or the air filtration unit to thereby control at least some environmental parameters relating to air quality inside the enclosed space.
3. A system according to any one of the preceding paragraphs, wherein the air pressuriser is located such that it is able to draw air from outside the enclosed space and direct the air into the enclosed space.
4. A system according to any one of the preceding paragraphs, wherein air that passes through the air pressuriser is directed into the enclosed space.
5. A system according to any one of the preceding paragraphs, wherein the air pressuriser may be located outside or inside the enclosed space.
6. A system according to any one of the preceding paragraphs, wherein the air filtration unit is located such that it is able to draw air from inside the enclosed space and direct the air into the enclosed space.
7. A system according to any one of the preceding paragraphs, wherein the air filtration unit may be located inside or outside the enclosed space.
8. A system according to any one of the preceding paragraphs, wherein in use of the system, a filter, provided in the air pressuriser, filters the air that passes through the air pressuriser and the air, which has been filtered, is directed into the enclosed space.
9. A system according to any one of the preceding paragraphs, wherein in use of the system, a filter, provided in the air filtration unit, filters the air that passes through the air filtration unit and the air, which has been filtered, is directed into the enclosed space.
10. A system according to any one of the preceding paragraphs, wherein the environmental parameters may be in respect of air quality, i.e. monitoring and controlling air quality in an enclosed space.
11. A system according to any one of the preceding paragraphs, wherein control of the operation of the air pressuriser and/or the air filtration unit comprises adjusting the speed of the respective motor of the air pressuriser and/or the air filtration unit if an input signal issued by a sensor and received by the controller indicates that the corresponding environmental parameter is not at a predetermined value or within a predetermined value range.
12. A system according to any one of the preceding paragraphs, wherein an alarm may be raised to alert the operator if an environmental parameter is not at the predetermined value, or within the predetermined value range, for a set time period. The set time period may be adjustable. This may be done in respect of all environmental parameters or only selected environmental parameters.
13. A system according to any one of the preceding paragraphs, wherein the first sensors may further include at least one airflow sensor to sense the airflow in the enclosed space. The at least one airflow sensor may sense the rate of flow of air in and/or into the enclosed space.
14. A system according to any one of the preceding paragraphs, wherein the first sensors may further include one or more sensors to sense the presence of one of more other gases (i.e. other than CO₂) in the enclosed space. The other gases, for example, may be one or more of SO₂, H₂S. However, sensors for any other gases may be included.
15. A system according to any one of the preceding paragraphs, wherein the system may also comprise second sensors. The second sensors sense parameters other than the parameters sensed by the first sensors. The second sensors do not monitor parameters that are indicative of the air quality inside the enclosed space. The second sensors monitor parameters that may affect the comfort level of a (human) operator in the enclosed space.
16. A system according to any one of the preceding paragraphs, wherein the first sensors are also referred to herein as the ‘first set of sensors’ or the ‘first sensors set’. The second sensors are also referred to herein as the ‘second set of sensors’ or the ‘second sensors set’.
17. A system according to any one of the preceding paragraphs, wherein the second sensors set may be divided into two groups: the first group of second sensors sense parameters and may issue input signals to the controller which in turn generates one or more output signals that are sent to the air pressuriser and/or the air filtration unit to control the operation of the air pressuriser and/or the air filtration unit.
18. A system according to any one of the preceding paragraphs, wherein, in the case of the second sensors in this first group, the purpose of controlling the operation of the air pressuriser and the air filtration unit is not to control the air quality inside the enclosed space, but rather to improve the comfort level of the environment of the enclosed space for the operator.
19. A system according to any one of the preceding paragraphs, wherein the second group of second sensors sense parameters and issue input signals to the controller, but the controller does not generate and send output signals, in response thereto, to control the operation of the air pressuriser and/or the air filtration unit. In the case of the second group of second sensors, the input signals received by the controller are stored in a data store.
20. A system according to any one of the preceding paragraphs, wherein sensors of the type in the first group of the second group of sensors include a sound sensor and/or a vibration sensor.
21. A system according to any one of the preceding paragraphs, wherein the system may further comprise at least one sound sensor to sense the sound level inside the enclosed space.
22. A system according to any one of the preceding paragraphs, wherein the sound sensor may measure the sound level inside the enclosed space in decibels.
23. A system according to any one of the preceding paragraphs, wherein the sound sensor may provide a reading of the sound level to which the occupant/s of the enclosed space are exposed.
24. A system according to any one of the preceding paragraphs, wherein the system may also further comprise at least one vibration sensor to sense vibration inside the enclosed space.
25. A system according to any one of the preceding paragraphs, wherein the vibration sensor may detect the level of vibration inside the enclosed space.
26. A system according to any one of the preceding paragraphs, wherein the vibration sensor may thus provide a reading of the level of vibration to which the occupant/s of the enclosed space, and/or equipment in the enclosed space, are exposed. Such readings may be saved in in a data store, which is accessible. The data store thereby provides a record of the vibration levels experienced by the occupant/s of the enclosed space and/or equipment in the enclosed space.
27. A system according to any one of the preceding paragraphs, wherein sensors of the type in the second group comprise a temperature sensor and a relative humidity sensor.
28. A system according to any one of the preceding paragraphs, wherein the system may further comprise at least one temperature sensor to sense the temperature inside the enclosed space.
29. A system according to any one of the preceding paragraphs, wherein the system may further comprise at least one relative humidity detector to sense the relative humidity inside the enclosed space.
30. A system according to any one of the preceding paragraphs, wherein one or more of the first sensors and second sensors may be provided in a sensor pod. For example, the dust sensor, CO₂ sensor, sensor/s for other gases, temperature sensor and relative humidity sensor may be provided in a single sensor pod. In alternative embodiments, one or more of these sensors may be provided in two or more sensor pods.
31. A system according to any one of the preceding paragraphs, wherein if required, the system may further comprise one or more interfaces with the controller.
32. A system according to any one of the preceding paragraphs, wherein a first interface is a user interface with the controller. The first interface allows a user, e.g. an operator located in the enclosed space, to interact with the controller.
33. A system according to any one of the preceding paragraphs, wherein the second interface is a web interface. The system may have a built-in wi-fi network and the web interface allows a user to connect with the controller via the built-in wi-fi network using a suitable device, e.g. a (laptop) computer or smartphone. LTE compatibility may be provided.
34. A system according to any one of the preceding paragraphs, wherein the third type of interface is an interface between the system and an OEM system. This third type of interface may be required, for example, if the enclosed space (or another device with which the enclosed space is associated, for example, a vehicle) has an OEM system that it is desired to interface with the system of the present invention.
35. A system according to any one of the preceding paragraphs, wherein the enclosed space (in which the air quality is monitored and controlled) may be a cabin or cabinet.
36. A system according to any one of the preceding paragraphs, wherein the cabin, for example, may be the cabin of a vehicle. One or more operators of the vehicle may occupy the cabin when the vehicle is in use and/or equipment may be located in the cabin.
37. A system according to any one of the preceding paragraphs, wherein the cabinet, for example, may be a cabinet containing equipment (e.g. electronics equipment). However, the enclosed space may be a building (including a demountable building) or a room occupied by personnel and/or in which equipment is located.
38. A system according to any one of the preceding paragraphs, wherein the system may be provided to monitor and control air quality in an enclosed space as a retrofitted installation.
39. A system according to any one of the preceding paragraphs, wherein the system may be provided in an enclosed space at the time of manufacture of the enclosed space or product having the enclosed space, for example, a vehicle.
40. A system according to any one of the preceding paragraphs, wherein the system may be provided in an enclosed space as an upgrade of an existing system in the enclosed space.
41. A method for monitoring and controlling environmental parameters in an enclosed space comprising
sensing the respective pressures inside the enclosed space and outside the enclosed space,
determining the differential pressure between the sensed pressure inside the enclosed space and the sensed pressure outside the enclosed space,
sensing the presence of dust particles in the enclosed space,
sensing the presence of CO₂ in the enclosed space,
generating one or more input signals indicative of the pressure differential, presence of dust particles and presence of CO₂ in the enclosed space,
generating one of more output signals in response to the input signals,
sending the output signals to an air pressuriser and/or an air filtration unit to control the operation of the air pressuriser and/or the air filtration unit to thereby control at least some environmental parameters relating to air quality inside the enclosed space.
42. A system or method according to any one of the preceding paragraphs, wherein control of the operation of the air pressuriser and/or the air filtration unit comprises adjusting the speed of the respective motor of the air pressuriser and/or the air filtration unit if an input signal indicates that the corresponding environmental parameter is not at a predetermined value or within a predetermined value range.
43. A system or method according to any one of the preceding paragraphs, wherein readings for the environmental parameters monitored may be recorded in a data store.
44. A system or method according to any one of the preceding paragraphs, wherein the system and method do not aim to monitor and control every environmental parameter in the enclosed space. In addition, the system or method does not necessarily control every environmental parameter that is monitored, for example, in the case of the enclosed space being the cabin of a vehicle, whilst temperature and relative humidity may be monitored, control of these parameters is usually handled by the existing HVAC system of the vehicle. However, monitoring such environmental parameters enables the readings from the monitoring to be recorded in a data store.
45. A system or method according to any one of the preceding paragraphs, wherein examples of other parameters that may be monitored and recorded in the data store include one or more of: the dust particle count; particle concentrations for various sizes of particles; typical dust particle size; air pressure; alert times, severity and details; and system changes and the identity of the personnel who made the change.
46. A system or method according to any one of the preceding paragraphs, wherein the data store can be accessed to analyse the data readings and fluctuations of the environmental parameter/s. This may be useful to identify any shortfalls in system performance which can then be investigated further and remedied if required.
47. A system or method according to any one of the preceding paragraphs, wherein some of the environmental parameters monitored may relate to air quality. Examples of environmental parameters that relate to air quality include the differential pressure level in the enclosed space, the level (or concentration) of dust particles, the level (or concentration) of CO₂ or other undesirable gases (e.g. SO₂, H₂S), airflow in the enclosed space and airflow into the enclosed space.
48. A system or method according to any one of the preceding paragraphs, wherein the differential pressure level in the enclosed space can relate to air quality because, for example, if the differential pressure level is not sufficiently high and the ambient environment outside the enclosed space has a relatively higher dust level, dust particles may find their way into the enclosed space thereby reducing the air quality in the enclosed space. Thus, the differential pressure level needs to be maintained as a positive pressure level or an overpressure level in the enclosed space.
49. A system or method according to any one of the preceding paragraphs, wherein the level (or concentration) of CO₂ or other undesirable gases (e.g. SO₂, H₂S) can relate to air quality because such gases can present serious adverse health effects on an occupant/s of the enclosed space and/or may be damaging to sensitive equipment in the enclosed space.
50. A system or method according to any one of the preceding paragraphs, wherein the airflow in the enclosed space (i.e. recirculated air in the enclosed space) can relate to air quality because, for example, if the level of dust detected in the enclosed space is undesirably high, the airflow needs to be at a sufficiently high level to flow air through the air filtration unit to filter the dust from the air.
51. A system or method according to any one of the preceding paragraphs, wherein the airflow into the enclosed space (i.e. the flow of air from outside the enclosed space into the enclosed space) can relate to air quality because, for example, if the level of an undesirable gas in the enclosed space is undesirably high, the airflow into the enclosed space needs to be at a sufficiently high level to flush out the undesirable gas from the enclosed space and replace it with fresh air. In such a case, the air flowing into the enclosed space needs to be clean (e.g. filtered air) so that the inflowing air does not contaminate the enclosed space.
52. A system or method according to any one of the preceding paragraphs, wherein some environmental parameters monitored may relate to the perceived comfort level of an occupant of the enclosed space. Examples of environmental parameters that relate to the perceived comfort level of an occupant of the enclosed space include the sound (or noise) level and the vibration level in the enclosed space.
53. A system or method according to any one of the preceding paragraphs, wherein if the controller determines that the pressure sensed in the enclosed space falls below a predetermined level, the controller sends an output signal to the motor of the air pressuriser to reduce the speed of the motor.
54. A system or method according to any one of the preceding paragraphs, wherein the system performs a pressure test on start-up to detect the current relationship between the speed of the motor of the air pressuriser and air pressure in the enclosed space.
55. A system or method according to any one of the preceding paragraphs, wherein the system employs PID control.
56. A system or method according to any one of the preceding paragraphs, wherein the system employs PID control and the PID control is used to calculate a motor speed correction for the motor of the air pressuriser and/or the motor of the air recirculation unit.
57. A system or method according to any one of the preceding paragraphs, wherein the controller signals an alert if the motor of the air pressuriser is running at or near its full speed and the pressure sensed inside the enclosed space is below a predetermined value.

1-28. (canceled)

29. A system for monitoring and controlling environmental parameters in an enclosed space comprising
a controller,
at least first sensors to monitor parameters indicative of air quality inside the enclosed space, the first sensors including
at least one pressure sensor to sense the pressure inside and outside the enclosed space,
at least one dust sensor to sense the presence of dust particles in the enclosed space,
at least one CO₂ sensor to sense the presence of CO₂ in the enclosed space,
an air pressuriser to filter and deliver air from outside the enclosed space into the enclosed space, and
an air filtration unit to filter air within the enclosed space,
wherein the difference between the pressure inside the enclosed space, sensed by the at least one pressure sensor, and the pressure outside the enclosed space, sensed by the at least one pressure sensor, defines a pressure differential, and
wherein the controller and the first sensors are in operative communication such that, in use, the controller receives one or more input signals from the first sensors and in response to the input signals the controller generates one or more output signals that are sent to the air pressuriser and/or the air filtration unit to control the operation of the air pressuriser and/or the air filtration unit by adjusting the speed of a respective motor of the air pressuriser and/or the air filtration unit to thereby control at least some environmental parameters relating to air quality inside the enclosed space, the air pressuriser operable to filter and deliver air from outside the enclosed space into the enclosed space and the air filtration unit operable to filter air within the enclosed space, and
wherein control of the operation of the air pressuriser includes
maintaining positive pressure in the enclosed space, and
increasing the speed of the motor of the air pressuriser to thereby increase the volume of air delivered by the air pressuriser to the enclosed space in response to
the controller receiving an input signal from the at least one pressure sensor that indicates that the differential pressure has fallen below a predetermined value, or
the controller receiving an input signal from the at least one CO₂ sensor that indicates that the CO₂ level in the enclosed space has exceeded a predetermined value, and
wherein control of the operation of the air filtration unit includes increasing the speed of the motor of the air filtration unit to thereby draw more air from within the enclosed space through the air filtration unit to cause more air to be filtered by a filter of the air filtration unit in response to
the controller receiving an input signal from the at least one dust sensor that indicates that the dust level in the enclosed space has risen above a predetermined value.

30. The system of claim 29, wherein control of the operation of the air pressuriser further includes increasing the speed of the motor of the air pressuriser to thereby increase the volume of air delivered by the air pressuriser to the enclosed space in response to the controller receiving an input signal from the at least one dust sensor that indicates that the dust level in the enclosed space has risen above a predetermined value.

31. The system of claim 29, wherein the first sensors further include at least one airflow sensor to sense the airflow in and/or into the enclosed space; and
wherein control of the operation of the air pressuriser further includes adjusting the speed of the motor of the air pressuriser to maintain the airflow in or into the enclosed space above a predetermined value in response to an input signal received by the controller from the at least one airflow sensor.

32. The system of claim 31, wherein at least one airflow sensor to sense airflow is provided at a filtered air outlet, of the air pressuriser, that directs filtered air into the enclosed space; and
wherein control of the operation of the air filtration unit includes adjusting the speed of the motor of the air filtration unit to maintain the airflow in or into the enclosed space above a predetermined value in response to an input signal received by the controller from the at least one airflow sensor.

33. The system of claim 32, wherein at least one airflow sensor to sense airflow is provided at an outlet, of the air filtration unit, that directs filtered air into the enclosed space.

34. The system of claim 29, wherein the first sensors further include one or more sensors to sense the presence of one of more other gases other than CO₂ in the enclosed space and wherein control of the operation of the air pressuriser includes increasing the speed of the motor of the air pressuriser to thereby increase the volume of air delivered by the air pressuriser to the enclosed space in response to the controller receiving an input signal from the one or more sensors to sense the presence of one of more other gases other than CO₂ that indicates that the level of the one of more other gases other than CO₂ in the enclosed space has exceeded a predetermined value.

35. The system of claim 29, wherein the system performs a pressure test on start-up to detect the current relationship between the speed of the motor of the air pressuriser and air pressure in the enclosed space.

36. The system of claim 35, wherein the system employs a PID control, the PID control used to calculate a motor speed correction for the motor of the air pressuriser and/or the motor of the air recirculation unit.

37. The system of claim 29, wherein the controller signals an alert if the motor of the air pressuriser is running at or near its full speed and the pressure sensed inside the enclosed space is below a predetermined value.

38. The system of claim 29, further comprising second sensors to sense environmental parameters other than the parameters sensed by the first sensors.

39. The system of claim 38, wherein the second sensors include a sound sensor to sense the sound level inside the enclosed space and/or vibration sensor to sense vibration inside the enclosed space.

40. A method for monitoring and controlling environmental parameters in an enclosed space comprising
sensing the pressure inside and outside the enclosed space,
determining the differential pressure between the sensed pressure inside the enclosed space and the sensed pressure outside the enclosed space,
sensing the presence of dust particles in the enclosed space,
sensing the presence of CO₂ in the enclosed space,
generating one or more input signals indicative of the pressure, presence of dust particles and presence of CO₂ in the enclosed space,
generating one of more output signals in response to the input signals,
sending the output signals to an air pressuriser and/or an air filtration unit to control the operation of the air pressuriser and/or the air filtration unit by adjusting the speed of a respective motor of the air pressuriser and/or the air filtration unit to thereby control at least some environmental parameters relating to air quality inside the enclosed space,
operating the air pressuriser to filter and deliver air from outside the enclosed space into the enclosed space,
operating the air filtration unit to filter air within the enclosed space,
wherein control of the operation of the air pressuriser includes
maintaining positive pressure in the enclosed space, and
increasing the speed of the motor of the air pressuriser to thereby increase the volume of air delivered by the air pressuriser to the enclosed space in response to
the controller receiving an input signal from at least one pressure sensor that indicates that the differential pressure has fallen below a predetermined value, or
the controller receiving an input signal from at least one CO₂ sensor that indicates that the CO₂ level in the enclosed space has exceeded a predetermined value, and
wherein control of the operation of the air filtration unit includes increasing the speed of the motor of the air filtration unit to thereby draw more air from within the enclosed space through the air filtration unit to cause more air to be filtered by a filter of the air filtration unit in response to
the controller receiving an input signal from at least one dust sensor that indicates that the dust level in the enclosed space has risen above a predetermined value.

41. The method of claim 40, wherein control of the operation of the air pressuriser further includes increasing the speed of the motor of the air pressuriser to thereby increase the volume of air delivered by the air pressuriser to the enclosed space in response to the controller receiving an input signal from the at least one dust sensor that indicates that the dust level in the enclosed space has risen above a predetermined value.

42. The method of to claim 41, further comprising sensing the airflow in and/or into the enclosed space, and control of the operation of the air pressuriser further includes adjusting the speed of the motor of the air pressuriser to maintain the airflow in or into the enclosed space above a predetermined value in response to an input signal received by the controller from at least one airflow sensor.

43. The method of claim 42, further comprising providing the at least one airflow sensor at a filtered air outlet, of the air pressuriser, that directs filtered air into the enclosed space.

44. The method of claim 42, wherein control of the operation of the air filtration unit includes adjusting the speed of the motor of the air filtration unit to maintain the airflow in or into the enclosed space above a predetermined value in response to an input signal received by the controller from the at least one airflow sensor, and providing the at least one airflow sensor at an outlet, of the air filtration unit, that directs filtered air into the enclosed space.

45. The method of claim 42, further comprising sensing the presence of one of more other gases, other than CO₂, in the enclosed space and wherein control of the operation of the air pressuriser includes increasing the speed of the motor of the air pressuriser to thereby increase the volume of air delivered by the air pressuriser to the enclosed space in response to the controller receiving an input signal from the one or more sensors to sense the presence of one of more other gases, other than CO₂, that indicates that the level of the one of more other gases, other than CO₂, in the enclosed space has exceeded a predetermined value.

46. The method of claim 42, further comprising performing a pressure test upon start-up to detect the current relationship between the speed of the motor of the air pressuriser and air pressure in the enclosed space.

47. The method of claim 42, wherein the method further comprises:
employing a PID control to calculate a motor speed correction for the motor of the air pressuriser and/or the motor of the air recirculation unit; and issuing an alert if the motor of the air pressuriser is running at or near its full speed and the pressure sensed inside the enclosed space is below a predetermined value.

48. The method of claim 42, further comprising sensing the sound level inside the enclosed space and/or sensing vibration inside the enclosed space.
